(19) United States
(12) Patent Application Publication
(10) Pub. No.: US 2004/0225865 A1
(43) Pub. Date: Nov. 11, 2004

(54) Integrated database indexing system

(76) Inventors: Richard D. Cox, Garland, TX (US); Brian L. Kurtz, Dallas, TX (US); Jay B. Ross, Pennington, NJ (US)

Correspondence Address: HOWISON & ARNOTT, L.L.P, P.O. BOX 741715, DALLAS, TX, 75374-1715, US

(21) Appl. No.: 10/871,858

(22) Filed: Jun. 18, 2004

Related U.S. Application Data
(63) Continuation-in-part of application No. 09/684,761, filed on Oct. 6, 2000.
(63) Continuation-in-part of application No. 09/389,567, filed on Sep. 3, 1999.

(51) Int. Cl. G06F 7/00

(52) U.S. Cl. 712/34

(57) ABSTRACT

An integrated database indexing system includes a database containing data and a query source communicably connected to the database. A query router connected to the query source communicates with an index engine. The index engine accesses an index associated with the data in said database. When query source communicates a command to the query router, the query router communicates the command to the index engine such that the index engine identifies result data in the data contained by the database.

### CROSS-REFERENCE TO RELATED APPLICATIONS

This application is a Continuation-in-Part of pending U.S. patent application Ser. No. 09/684,761 (Atty Dkt. No. NEXQ-26,593) entitled “ENHANCED BOOLEAN PROCESSOR WITH PARALLEL INPUT,” and U.S. patent application Ser. No. 09/389,567 (Atty. Dkt. No. NEXQ-24,727) entitled “UNIVERSAL SERIAL BIT STREAM PROCESSOR.”

### TECHNICAL FIELD

This disclosure relates to the field of database management systems, in particular integrated systems including hardware query accelerators.

### BACKGROUND OF THE INVENTION

Modern data access systems attempt to provide meaningful access to the enormous amounts of data that may be relevant to any researcher, analyst, organization, group, company or government. The data access systems attempt to provide access to large quantities of data, possibly stored in a variety of data formats in a number of disparate modern and legacy databases. In some cases, the access to data needs to be provided in real-time.

It would therefore be advantageous to provide an integrated database management system that manages data and queries.

An integrated database management system may be able to provide access to legacy databases. Data stored in legacy databases may have become relatively inaccessible and so is often left generally untapped. A database management system is needed to provide integration of the data found in legacy databases into modern database indexing systems

Some organizations routinely handle extremely large amalgamations of data. Some types of organizations, like governments, telecom companies, financial institutions and and retail companies often require the ability to access and query a variety of databases. Even where the databases are extremely large and spread across disparate databases and database formats, the organizations may need the ability to query the data with something approaching a real-time response.

A database management system is needed to complement and enhances the real-time capability of existing large scale, disparate SQL-compliant databases and related infrastructure.

### SUMMARY OF THE INVENTION

An integrated database indexing system includes a database containing data and a query source communicably connected to the database. A query router connected to the query source communicates with an index engine. The index engine accesses an index associated with the data in said database. When query source communicates a command to the query router, the query router communicates the command to the index engine such that the index engine identifies result data in the data contained by the database.

### BRIEF DESCRIPTION OF THE DRAWINGS

For a more complete understanding of the present invention and the advantages thereof, reference is now made to the following description taken in conjunction with the accompanying Drawings in which:

FIG. 1 depicts a functional block diagram of a simple integrated database indexing system;

FIG. 2 depicts a functional block diagram of an expanded integrated database indexing system;

FIG. 3 depicts a functional block diagram of a networked integrated database indexing system;

FIG. 4 depicts a functional block diagram of a database;

FIG. 5 depicts a functional block diagram of an index engine;

FIG. 6 depicts a memory map of an index engine memory;

FIG. 7 depicts a database table;

FIG. 8 depicts a binary balanced tree;

FIG. 9 depicts a row group arrangement in an index engine memory;

FIG. 10 depicts a row group arrangement in an expanded index engine memory;

FIG. 11 depicts a row group arrangement in a redundant index engine memory;

FIG. 12 depicts a functional block diagram of an integration server;

FIG. 13 depicts a sequence diagram for a define schema function;

FIG. 14 depicts a sequence diagram for a partition function;

FIG. 15 depicts a sequence diagram for a create index function;

FIG. 16 depicts a sequence diagram for an insert index function;

FIG. 17 depicts a sequence diagram for a delete index function;

FIG. 18 depicts a sequence diagram for an update index function;

FIG. 19 depicts a sequence diagram for a simple query function;

FIG. 20 depicts a sequence diagram for a Boolean query function.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

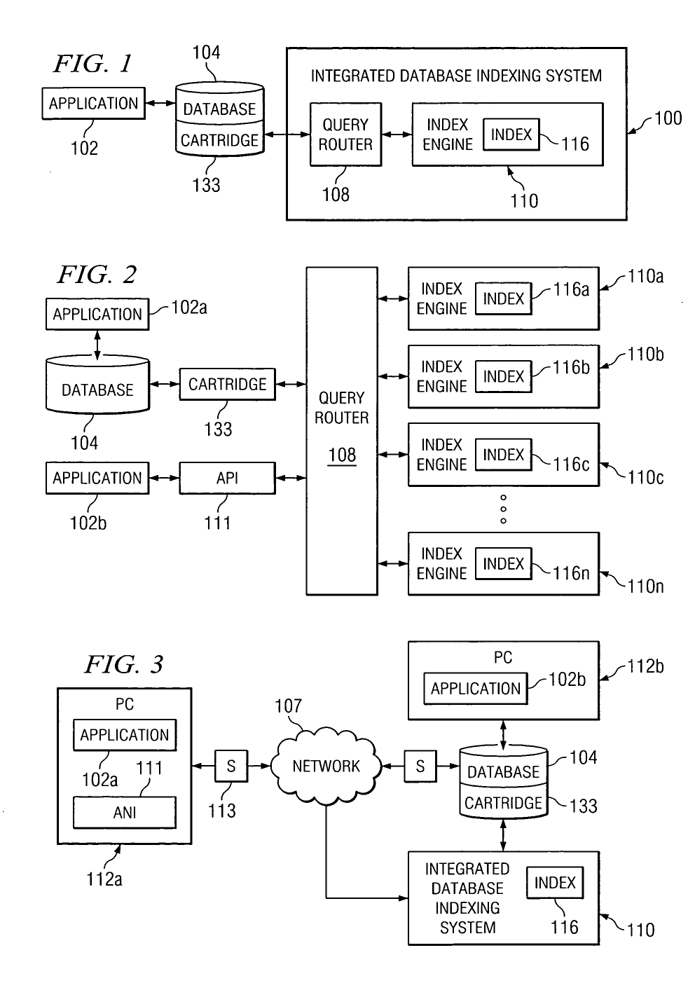

With reference to FIG. 1, an integrated database indexing system 100 in accordance with a disclosed embodiment is shown. Users of the integrated database indexing system 100 interface with an application 102. The application 102 may typically be any computer program or other function that generates database query or index management requests for a database 104. Generally, application 102 generates queries, index management requests or other instructions in a structured query language, such as SQL. The application 102 may generate queries for data that is stored in a database 104. The application 102 may generate index management requests to update the index 116 stored in index engine 110.

The application 102 may communicate with a database 104. In accordance with the disclosed embodiment, the database may be an Oracle database having the Oracle8i Extensibility Framework or any database including an integrated extensible indexing feature. The extensible indexing feature implements the creation of domain specific object types with associated attributes and methods that define their behavior. The extensible indexing framework allows users to register new indexing schemes with the database management system. The user provides code for defining index structure, maintaining the index 116 and for searching the index during query processing. The index structure may be stored in database tables. An optimizer framework allows users to provide cost and selectivity functions for user defined predicates as well as cost and statistics collection functions for domain indexes.

An extensible indexing database may provide an interface that enables developers to define domain-specific operators and indexing schemes and integrate them into the database server. The database 104 provides a set of built-in operators, for use in SQL statements, which include arithmetic operators (+, −, *, /), comparison operators (=, >, <), logical operators (NOT, AND, OR), and set operators (UNION). These operators take as input one or more arguments (operands) and return a result. The extensibility framework of the database 104 allows developers to define new operators. Their implementation is provided by the user, but the database server allows these user-defined operators to be used in SQL statements in the same manner as any of the predefined operators provided by the database 104.

The framework to develop new index types is based on the concept of cooperative indexing, where the integrated database index system 100 and the database 104 cooperate to build and maintain indexes for various data-types. The integrated database index system 100 is responsible for defining the index structure, maintaining the index content during load and update operations, and searching the index 116 during query processing. The index structure itself can be stored either in the database 116 as tables or in the index engine 110. Indexes 116 created using these new index types may be referred to as domain indexes.

Import/export support is provided for domain indexes. Indexes 116 (including domain indexes) are exported by exporting the index definitions, namely the corresponding CREATE INDEX statements. Indexes 116 are recreated by issuing the exported CREATE INDEX statements at the time of import. Because domain index data stored in database objects, such as tables, is exported, there is a fast rebuild of domain indexes at import time.

The extensible framework is interfaced with user-defined software components referred to as data cartridges or index agents 133 that integrate seamlessly with each other and the database 116. Data cartridges 133 may be server-based. The data cartridge 133 constituents may reside at the server or are accessed from the server. The bulk of processing for data cartridges 133 occurs at the server, or is dispatched from the server in the form of an external procedure.

Data cartridges 133 may extend the server. They define new types and behavior to provide componentized, solution-oriented capabilities previously unavailable in the server. Users of data cartridges 133 can freely use the new types in their application to get the new behavior. Having loaded an Image data cartridge, the user can define a table Person with a column Photo of type Image.

Data cartridges 133 may be integrated with the database server. The extensions made to the server by defining new types are integrated with the server engine so that the optimizer, query parser, indexer and other server mechanisms recognize and respond to the extensions. The extensibility framework defines a set of interfaces that enable data cartridges 133 to integrate with the components of the server engine. For example, the interface to the index engine 110 may allow for domain-specific indexing. Optimizer interfaces similarly allow data cartridges 133 to specify the cost of accessing data by means of its functionality.

Data cartridges 133 may be packaged. A data cartridge 133 may be installed as an unit. Once installed, the data cartridge 133 handles all access issues arising out of the possibility that its target users might be in different schema, have different privileges and so on.

An API or Integration Server 103 provides an interface between the application 102 and the other components of the integrated database indexing system 100. The integration server 103 accepts queries from the application 102. The integration server 102 receives results from the database 104 and may transform the results of the query into a format specified by the application 102. A typical format may be a standard generalized markup language (SGML) such as an extensible markup language (XML). The integration server 103 provides a transparent interface between the application 102 and the database 104, preventing format incompatibilities between the application 102 and the database 104.

The integrated database indexing system 100 includes a query router 108. The query router 108 may be in communication with the integration server 103. In accordance with another embodiment, the query router 108 may communicate with the database 116. Queries and other index management commands are communicated to the query router 108 by the integration server 103. The queries are parsed and communicated to an index engine 110.

The index engine 110 searches the query using an index for the database 104. When the search has been performed, the index engine 10 generates rowID data that typically includes the database rowIDs associated with the result data sought in the query. A rowID consists of three parts: file ID, block number and slot in this block. As a slot can be occupied at most by one row, a rowID uniquely identifies a row in a table. The index engine 10 communicates the result data to the query router 108. The query router 108 communicates the result data to the database 104. The database 104 uses the rowIDs in the result data to retrieve the result data. The database 104 communicates the result data to the integration server 103. The integration server 103 formats the result data into an appropriate format and communicates the formatted result data to the application 102.

An integrated database indexing system 100 may be implemented in a variety of ways, including specialized hardware and software. Through the use of software components run on general purpose computers and index engine software implemented on dedicated hardware components, the integrated database indexing system 100 may be used to conduct queries for large scale, complex enterprises. The software and hardware components may be provided on industry-standard platforms. The use of standardized equipment and software to implement an integrated database indexing system 100 may significantly reduces operational risks and may provide a dramatic reduction in implementation time and total cost of ownership.

The integrated database indexing system 100 allows the generation of real-time query results across very large, disparate databases 104. In accordance with the disclosed embodiment, the integrated database indexing system 100 may be designed to query data in any specified database 104, where the data in the database 104 is in any database format.

An index agent 106 may be communicably connected to the database 104 and the query router 108. The index agent 106 tracks changes in the database 104 and communicates those changes to the query router 108. In accordance with a disclosed embodiment, the index agent 106 is a software-based component. Typically, the integrated database indexing system may be associated with the database 104. The integrated database indexing system 100 provides fast indexing and index management, which is particularly useful in high ingest, high change index uses. The speed of a query may be irrelevant if the indexes are not updated at an sufficient speed.

With reference to FIG. 2, an integrated database indexing system 100 in accordance with another embodiment is shown. The integrated database indexing system 100 may process queries from any number of applications, shown here as two applications 102a and 102b. One application 102b is shown as connected to an API 111. In accordance with other embodiments, the applications may be connected to an integration server by a network, including a local-area network or an open network such as the Internet. Each of the applications 102a and 102b may be different instances of the same application. Each of the applications 102a and 102b may be unique applications using different query languages, formats and result format needs.

The API 111 receives query commands from the application 102b. Each query command is formatted by the integration server 111, if necessary, typically from the application command format into an integrated database indexing system format. The formatted query command is communicated to the query router 108. The query router 108 parses the query command for communication to an index engine 110a.

The integrated database indexing system may include one or more index engines, shown here as four index engines 110a, 110b, 110c and 110n. Typically each index engine, 110a, 110b, 110c and 110n store a unique database index 116a, 116b, 116c and 116n, although one or more of the index engines 110a, 110b, 110c and 110n may include redundant database indexes. One advantage to the integrated database indexing system comes from the fact that increasing the number of index engines increases the speed of indexing and querying, so that scaling becomes an advantage of the system rather than a liability in most cases.

Given a query, the query router 108 selects one or more index engines 110a, 110b, 110c and 110n The selection of an index engine 110 may be determined based on knowledge of the indexes 116 stored in the index engine 110, search traffic management or other parameters. The query router 108, having selected an index engine 110, communicates the parsed query to the index engine 110. Where multiple index engines 110a, 110b, 110c or 110n have been selected by the query router 108, the query router 108 communicates the parsed query to each of the selected index engines.

The query router 108 may be communicably connected to any number of databases, shown here as two databases 104a and 104b. Typically, each of the many databases 104a and 104b contain unique data, although there may be some redundancy in the databases or even redundant databases. Each of the databases 104a and 104b has an associated database index 116 stored in the index engines 110.

The selected index engines 110a, 110b, 110c and 110n search the query using indexes for the databases 104a and 104b. When the searches have been performed, the selected index engines 110a, 110b, 110c and 110n generate rowID data that typically includes database rowIDs associated with the result data sought in the query. A rowID consists of three parts: file ID, block number and slot in this block. As a slot can be occupied at most by one row, a rowID uniquely identifies a row in a table. The selected index engines 110a, 110b, 110c and 110n communicate the result data to the query router 108. The query router 108 communicates the result data to the databases 104a and 104b. The databases 104a and 104b use the rowIDs in the result data to retrieve the result data. The databases 104a and 104b communicate the result data to the integration server 103. The integration server 103 formats the result data into an appropriate format and communicates the formatted result data to the application 102.

The integrated database indexing system 100 may be optimized for integration with large, complex enterprises including a variety of large, disparate databases 104a and 104b, with data in various formats. With the operation of the integrated database indexing system 100, the data in existing databases 104a and 104b may be tied together in a transparent fashion, such that for the end user the access to data is both business and workflow transparent.

With reference to FIG. 3, an integrated database indexing system 100 is shown in a network context. The integrated database indexing system 100 may be directly connected to a query source such as an application 102b executed on a device 112b such as a personal computer. The integrated database indexing system may be directly connected to one or more databases 104. The integrated database indexing system 100 may be connected to a network 107, such as a local area network or an open network such as the Internet. A query source such as an application 102a executed on a device 112a may be connected to the network 107, typically using an application network interface 111. A security layer 113 may be implemented, particularly on network connections, to provide security to the communications.

An application network interface 111 may be implemented to provide an interface between an application 102 and a network 107 and provide communication with the integrated database indexing system 100. The application network interface 111 may enable an application 102a on desktop machines 112a send query requests and receive results from the integrated database indexing system 100 via the Internet 107 using TCP/IP. This type of remote access allows users, which may be a user at a desktop machine 112a to communicate with the integrated database system 100 using an open network 107, such as the Internet, providing an easy and familiar interface and location independent interaction. With network access to the integrated database indexing system 100, users are capable of querying the data in disparate databases 104 from any location. By using a web-browser interface, the query format and even a given user or group of users' capabilities can be defined by the forms provided.

The integrated database indexing system 100 may provide support for ANSI standard SQL 92 or 98 CORE or any database query language. The query parser may support the ANSI standard SQL 92 or 98 CORE languages. SQL-92 was designed to be a standard for relational database management systems (RDBMSs) SQL is a database sublanguage that is used for accessing relational databases. A database sublanguage is one that is used in association with some other language for the purpose of accessing a databases

The integrated database indexing system 100 may provide support for standard DML (data manipulation language) within the integrated database indexing system 100. Standard DML may typically include commands such as Create Index, Load Index, Drop Index, Rebuild Index, Truncate Index, Alter Index, Create Database, Drop Database, Alter Database.

The integrated database indexing system 100 may provide support for standard DDL (data definition language). In this way, the integrated database indexing system 100 may provide the ability to read standard DDL within a database schema and create the appropriate indexing support in the integrated database indexing system 100.

The integrated database indexing system 100 may support a variety of index types including Primary Key, Foreign Key, Secondary Indexes (Unique and Non-Unique), Concatenated Keys.

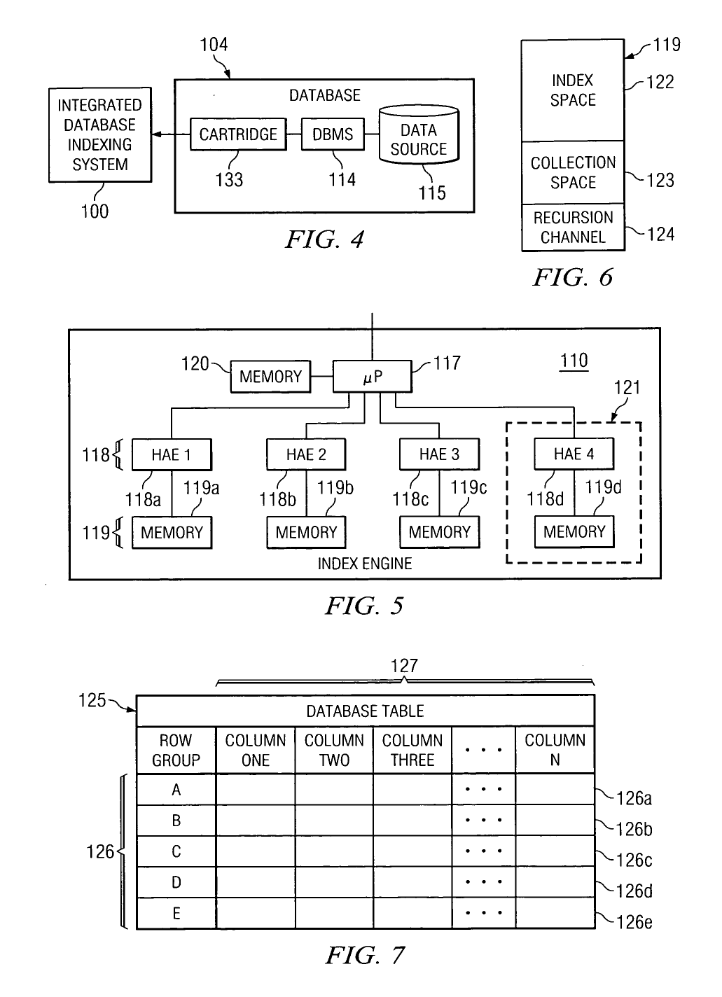

With reference to FIG. 4, a functional block diagram of a database 104 connected to an integrated database management system 100 is shown. The database 104 may include a data cartridge 133, a database management system 114 and a data source 115. Those skilled in the art will recognize that these functions may be localized in a single device 104 or may be implemented on a multiplicity of communicably connected devices. In some embodiments, the database cartridge 133, the database management system 114 or data source 115 may be implemented within the integrated database indexing system 100, particularly where the integrated database indexing system 100 is implemented specifically for use with the database 104.

The use of index trees in conjunction with vectors by index engine 110 within the integrated database indexing system 100 enables the creation and maintenance of balanced binary trees and bit vectors based on the index or indexes that have been defined within schema or schemas in a given database management system.

A Boolean engine and optimizer in an index engine 110 may provide the integrated database indexing system 100 with the ability to perform relational algebra on the bit-vectors by isolating the RowIDs of interest. The RowID information may in this way provide the database management system 100 with optimal path execution.

The integrated database indexing system 100 may include persistence and checkpoint restart, which enables the periodic flush of in-memory indexes to disk along with check-points for added resilience with full configurability such as timing.

A logging function may be implemented on the integrated database indexing system 100 to capture all query requests, exceptions and recovery information. The logging function may typically be be turned on or off when provided.

The integrated database indexing system 100 may provide a connection function and a session management function. The connection function may establish and manage end-user connections to the underlying database management system 114. Session management functions may create connection pools and manage all connection handles and sessions.

A query reconstruct function may enable the integrated database indexing system 100 to reconstruct the incoming query that was parsed. The query resconstruct allows RowIDs that have been isolated and identified to be substituted in the query and sent to the back-end database management system 114 for processing.

Merge and join functions allow the integrated database indexing system 100 to merge resulting data from multiple databases, such as databases 104a and 104b, when a query requires queries are performed across multiple databases.

Metadata management may be performed by a query router where the integrated database indexing system 100 requires a description of catalogs for each target schema within the database platform. The integrated database indexing system 100 may include metadata that may be designed to provide crucial information about target schema specifics such as a table-space names, table names, index names and column names.

An index agent 106 may provide the ability to capture updates to index values in the database index 116. The index agent 106 may then notify the index engine 110 of updates for posting in real-time. The index agent 106 may move updated objects to a cache for retrieval. The index agent 106 may provide a persistence capability as a pre-cautionary measure if one or more of the integrated database indexing system 100 components are rendered unavailable by a power outage or some other dysfunction. The index agent 106 may be designed to provide checkpoint and restart facilities as well.

The integrated database indexing system 100 may include a backup restore function to provide the ability to backup and restore software components of the integrated database indexing system 100 from persistent data storage, such as a magnetic disk, optical disk, flash memory.

The integrated database indexing system 100 may include exception management functions including fault detection, software execution failures and native database management system return codes with appropriate handling and self-recovery routines

The integrated database indexing system 100 may include monitoring functions, including facilities that may be designed to monitor performance and exceptions of the integrated database indexing system 100. The monitoring functions typically may be implemented with a GUI interface,

A software installer function may be provided on the integrated database indexing system 100 to provide out-of-the-box user installation facilities. The software installer function may facilitate the installation and configuration of the software aspects of the integrated database indexing system 100.

The integration server 103 may typically provide extensible markup language (XML) support. XML support may provide the ability to take an incoming Xpath/Xquery XML stream and translate the stream into a native SQL command. The SQL command may be issued to the underlying database management systems. XML support further provides the ability to repackage the result set into XML output.

The integrated database indexing system 100 may include one or more integrated database indexing system device drivers. The device drivers may provide interfaces allowing the indexing engine to communicate with the Boolean engine. In this way, the integrated database indexing system 100 may be able to perform relational algebra on isolated bit vectors in hardware.

The index engine 110 may be configured as a Boolean query acceleration appliance. A Boolean query acceleration appliance suitable for use in an integrated database indexing system 100 is taught in U.S. Pat. No. 6,334,123, which is herein incorporated by reference. The index engine 110 may be a rack mounted hardware device. By using a small, compact rack-mountable design, packaged in a rack mountable chassis, various levels including 1U, 3U and 8U systems, can be easily configured. In accordance with the preferred embodiment, the index engine 110 may use standard rack mount power and disk arrays.

The in-system control processor complex of a typical integrated database indexing system 100 may include dual IBM PPC970 2.4 Ghz processors, with Altivec, 4 gigabytes of DDR 400 Mhz SDRAM for each processor, SCSI or FC disk interface, 2 1 GB Ethernet links, 24 8 Gb PCI Express links, 2 or 3 serial UARTs for debug.

The preferred fault tolerance design for the integrated database indexing system 100 may include a processor card and hardware acceleration modules. The fault tolerance design may also include persistent data storage such as magnetic disks, optical disk or flash memory, and power supplies that are redundant and can failover while maintaining functionality.

The index engine 110 may include hardware query acceleration enabled through custom chip design. The hardware query acceleration modules may be capable of 60 billion operations per second. In accordance with one embodiment, each hardware acceleration card may include 64 Gigabytes per card, providing a total of 768 gigabytes in the system. Other embodiments may include hardware acceleration cards having 128 gigabytes per card, for a total of 1.5 terabytes per system.

In the operation of the integrated database indexing system 100, indexes may be stored in active memory devices such as RAM. Persistent storage medium such as magnetic disks may be used only for backup. In accordance with one embodiment, a 768 gigabytes system may be able to store a database having a size in excess of 100 terabytes.

The integrated database indexing system 100 may include an upgradeable and customizable design that includes systems consisting of, for example, multiple processor card slots and multiple hardware acceleration modules slots. In accordance with a preferred embodiment, two processor card slots may be provided. In accordance with a preferred embodiment, twelve hardware acceleration module slots may be provided. The upgradeable design provides means for upgrading the integrated database indexing system 100 with additional, improved or customized cards within the same platform. The utilization of field-programmable gate arrays (FPGAs) allows the core hardware logic to be updated and customized to a specific customer's need, if necessary.

The integrated database indexing system 100 provides working performance with real time results on large databases in excess of 100 terabytes. The integrated database indexing system 100 provides real-time indexing solutions, acting as a bridge between applications that access data and the data sources that are accessed.

The integrated database indexing system 100 may advantageously be deployed where real-time access to critical information is necessary or when queries against multiple, disparate databases need to be issued. In the case of real-time access, the integrated database indexing system 100 operates as a simple database query accelerator. In the case of aggravating multiple disparate databases, the integrated database indexing system 100 hides the complexities of retrieving data from applications that need access to the data in the diverse databases.

The integration server 103 typically generates requests communicated to the query router 108. These requests may include index column additions, index additions, index deletions and index updates. The query router 106 processes these requests with the assumption that the data source is a SQL-based relational database. When other types of data sources are present in the system, the communication process with the data source will change, however, the logical process flow is maintained.

The query router responds to requests to add an index when the system is first configured, whenever a create index statement is issued in a SQL database, or when a request to add a new value to the system results in a specified column not being found in the master virtualized schema. In all cases, the query router may follow the same basic process for the addition of indexes.

The integration server 103 may communicate a request to add an index having the following form:

<database_identifier>; <table_identifier>;<column_identifier>

where <database_identifier>indicates the data source, <table_identifier>indicates which table is to be updated from the data source, and <column_identifier>indicates which column is to be indexed. The <column_identifier> may contain information about more than one column if a create index statement created a concatenated or clustered index in the underlying database management system.

Upon receipt of a request to add a column, the query router 106 (1) updates the metadata catalog and (2) updates the master index tree.

In order to add the column to the metadata, the column must be tied to the table in the underlying database management system to which it belongs. This is accomplished by queueing the metadata catalog for the existence of the database contained in <database_identifier>, extracting information from <table_identifier> and associating it with information contained in the <column_identifier>. Once the namespace-specific schema has been updated, a mapping is attempted between columns that already exist in the master virtual schema. This mapping is first weighted on column type, then on column length and finally on column name. If a mapping cannot be found, the column is added to the virtual schema and is then available to future mapping operations.

After all metadata updates have completed, the query router obtains the domain of values for the column to be indexed. This is accomplished by issuing a query to the DBMS 114 that contains the column and value information:

SELECT DISTINCT <column_name> FROM <table_name>

Once the domain of values has been established, the query router 106 retrieves RowIDs from the column in the database management system. A query such as the one below is used to obtain the RowIDs:

SELECT ROWID FROM <table_name>WHERE <column_name>=‘<value>’

Each query in the set will return a set of RowIDs for the given value. For each set of returned RowIDs, the query router requests a block of memory from the index engine 110. The block is then filled with the retrieved RowIDs, the physical block address is stored in the master index tree with the value, and a memory flush is performed to write the RowIDs back to the hardware.

The query router 106 responds to requests to add new values to an existing index when a new row is added to an underlying database and it is determined that the value that was added has not been seen before by the query router 106.

In order to determine if a value has been seen before, the integration server 103 creates a thread that sends a request to the query router. The format of the request is as follows:

<header>; <database_identifier>;<table_identifier>;<column_identifier>

Note that the last three parts of the request to add a new value are typically the same as when adding a new index into the system. The <header> that is passed as part of the information request contains an indicator that specifics that this is a value information request and contains the value to be queried.

When the query router 106 receives the requests it first strips off the header and saves the value to be queried. Once the header has been stripped off, the metadata catalog on the query router is queried to find information about how the column of interest is mapped into the master virtual schema. If it is determined that the column of interest has not been mapped into the virtual schema, the namespace-specific schema for the database in question is checked. If no information about the column of interest exists in the metadata catalog then an indexed column is added.

Once a valid virtualized column name has been determined, the query router 106 then navigates to the appropriate node in the master index tree and navigates to the node for the value in question. If a node for the given value is found, the query router returns a status code to the integration server 103 that indicates that the value exists; the integration server thread that initiated the request is then free to terminate and no further work to add the value takes place on the query router.

If the value in question is not found in the master index tree, the query router 106 adds the value to the master index tree and issues a query in the following form to obtain the set of RowIDs that contain the value from the underlying database management system:

SELECT RowID FROM <table_name>WHERE <column_name>=<value>

Note that adding a value to the master index tree may force a rebalance of one or more subtrees in the master index tree. On any given re-balance, no more than 512 nodes will ever be affected by the re-balancing operations. Thus, rebalancing should not be a major factor in perceived system performance.

Once a set of RowIDs is returned, memory in the index engine 110 is either allocated or extended to hold the new value and a physical starting address for the new list of RowIDs is returned to the query router 106. This physical address is then added to the list of physical addresses present at the node in the master index tree that holds the value and the set of RowIDs for the given value is passed to the index engine 110.

Once the index engine hardware has added the RowID list to its memory, the query router returns a status code to the integration server 103 to indicate that the new value has been added to the master index tree; the integration server thread that initiated the request is now free to terminate.

When a row that contains an indexed value is deleted in the underlying database management system, the query router receives a notification of deletion from the integration server. The format of the deletion notification is as follows:

<header>;<database_identifier>;<table_identifier>;<column_identifier>

The <header> for a deletion request consists of a list of RowIDs that were affected by the deletion; in the case of the deletion of a single row, the list will contain exactly one element.

When a deletion notification arrives the query router 106 places the deletion request in the deletion queue. In order to determine if the value is deleted in the underlying database management system, the query router 106 obtains a connector for the database from its connection pool and issues the following query to the database management system:

SELECT*FROM <table_name>WHERE ROWID=<rowid>

This query is issued periodically until the query router 106 receives a response from the database server that the underlying RowID has been removed from the database.

When the RowID is known to be deleted, the query router 106 retrieves the deletion request from the deletion queue. The database management system specific name of the column is determined from the deletion request; this name is then matched to the virtualized name contained in the metadata catalog.

Using the virtualized name, the query router 106 then navigates its master index tree until it finds the value and consults the list of physical addresses stored at the value node. Once the list of physical addresses has been identified, the query router 106 then consults information stored with the physical addresses to determine the range of RowIDs stored at a given physical address until it finds a range that contains the RowID that was passed to it. Having now found the appropriate range, the query router 106 maps the memory at the physical address in the index engine hardware into its own process address space.

After mapping the index engine memory, the query router 106 then performs a search of the memory to determine the exact offset of the given RowID in the memory block. Once the offset has been determined, the query router 106 marks the RowID as deleted in the memory block and flushes the changes back to the hardware.

The deletion of an index (i.e. the deletion of all values associated with a column) is similar with the exception that in the case of a total index deletion the metadata catalog is updated to reflect the fact that both a namespace-specific and virtualized column has been removed from the schema.

When a row that contains an indexed value has been changed, a request in the following form is sent to the query router 106:

<header>;<database_identifier>;<table_identifier>;<column identifier>

The <header> portion of a change request contains information about the change, typically an indication of the value that changed, the value that was finally given, and a list of the RowIDs that were affected by the change.

Once the query router 106 receives the request, the query router 106 queues all change requests it receives until it can be determined that the change has not been rolled back in the underlying database, because changes to the system affect the quality of results returned. If it is determined that a change to be applied was rolled back, the change request is discarded and no further processing takes place for the request.

If the change was successfully applied, the query router 106 proceeds by retrieving the next pending change request from the change queue and extracts the information necessary to apply the update, including the native column name, the previous value, and the updated. Once this information has been determined, the query router 106 queries its metadata catalog to discover the virtualized name of the column.

The query router 106 navigates a master index tree to locate the value that needs to change. After determining the location of the source value, the query router 106 determines if it needs to do a split in the value tree or just needs to update the value and possibly re-balance the values. A split in the value tree occurs when less than the full amount of RowIDs tracked by the value is affected. In this case, the physical addresses of the affected RowIDs are removed from the list of addresses present at the value node and the new value is inserted with a pointer to the physical addresses of the affected RowIDs. If all of the RowIDs are affcted, the value at the node is updated and the value trees are rebalanced if necessary.

The index engine 110 handles the processing load for the generation of RowID information. The index engine 10 communicates with the query router 106 from which it receives requests to process index information or manage the indexes in the case of a change.

With reference to FIG. 5, the index engine 110 may be configured to include an index engine processor 117 and associated memory 120. The index engine processor 117 communicates with one or more hardware acceleration elements 118 (HAEs), here shown as four HAEs 118a, 118b, 118c and 118d. It will be recognized that any number of hardware acceleration elements 118 may be implemented. The hardware acceleration elements 118 may hold RowID values of the indexes. These hardware acceleration elements 118 can execute in parallel with virtually unlimited scaling capability. Each of the hardware acceleration elements 118 may have an associated memory 119, here shown as four memory devices 119a, 119b, 119c and 119d.

The increased query performance may be due to the indexing algorithm, the compressed nature of the indexes and the fact that all the indexes are stored in high-speed RAM 119. In accordance with the disclosed embodiment, memory 119 is implemented as field-programmable gate arrays (FPGA).

A portion of the performance of the index engine 110 is predicated on the use of RAM as memory 119 for storing indexes. By doing so, the limitations of disk systems can be overcome. Hardware acceleration elements 118 may store the indexes of the database 104, as well as intermediate and final query results.

The index engine 110 may include field replaceable units 121 containing dedicated memory 119 and a custom Boolean engine 118. In order to store indexes and fulfill queries, the memory 119 associated with each hardware acceleration element 118 may be segmented into three blocks or “spaces.”

With reference to FIG. 6, a hardware acceleration memory 119 map is shown. Typically, 75% of the memory 119 is used as index space 122, with 20% for collection space and 5% for the recursion channel. The percentages given are typical, however, actual distributions will be adjusted for the requirements of a given system implementation.

The index space 122 of the memory 119 stores the indexes that allow the index engine 110 to perform its high-speed queries. For completed queries, each hardware acceleration element 118 stores intermediate or final results. The collection space 123 addresses this issue by allocating space on a per-query basis. Finally, some queries require temporary memory space for each query that isn't a part of the collection space 123. The recursion channel 124 is utilized for back to back queries when one query result is being recursed back into the second.

Each index space 122 contains indexes which are simply a list of RowIDs. Although these indexes can exist in different states, such as lists, threads and bitvectors, they are simply different forms of the same data. These index structures have no fixed size, and will grow as the database grows. To accommodate organic growth, the index engine 10 will mimic a file system, in that the entire memory space will be divided into even sized clusters. A cluster size of about 4 K bytes may be used. With 64 GB of index space, this cluster size provides memory for approximately 16 million clusters. To keep track of available clusters, when a single bit is allocated for each of the clusters, a 2 megabyte array is needed (a ‘1’ in the array indicates a used cluster, while a ‘0’ indicates an available cluster.

This method results in a straight-forward approach of allocating new blocks; simply scan the array until a value other than 0×FFFF FFFF is found. A queue of available clusters, ordered first to last, is maintained to expedite the process of finding an available cluster.

While the cluster allocation table allows the index engine 110 to maintain clusters, it doesn't define which indexes are stored in which cluster. Therefore, the starting cluster (index engine number+physical address) is maintained in the balanced binary trees. After the first cluster of an index is located and read by the index engine 110, the next clusters location can be resolved and the process continues until the last cluster for the index is read. The high level structure of cluster may include 32 bits defining the type list and bitvectors, and also describes compression if any. The physical address of the next cluster is defined in 32 bits including the NextCluster list and bitvectors. A first 32 bits define the left pointer for the tree structure and a second 32 bits define the right pointer for the tree structure. The remainder of the cluster is used to store the data payload including the actual indexes.

As discussed earlier, collections are the result of every Boolean operation in the hardware acceleration elements 118. The fact that collections are generated by hardware and are of undetermined length means that software cannot directly manage their locations like in the index space 122.

To resolve this, the hardware acceleration element 118 receives a start location before each operation and starts placing the result there and continues linearly through the memory 119 until the process is complete. Because the hardware acceleration element 118 will do this blindly, the query router 106 will ensure that there is sufficient space for the required operation, taking into account the database size and worst case compression. Once the operation has been completed, the index engine 110 will return the last location used, which the query router 106 will use as the next collection starting point.

Eventually, this process will use all available memory, at which point it will be necessary to either purge old collections or swap to disk. Since collections can be purged in a non-consecutive manner, the query router 106 may occasionally defragment the collection space 123, to allow for a new collection.

The recursion space 124 is used for temporary collection space. Recursion space 124 contains dedicated space for two worst case collections.

In order to support large databases, the indexes can be distributed across several hardware acceleration elements 118a, 118b, 118c, 118d within one or more index element 110. The method of distribution should allow for organic growth of the database within each index engine 110, provide system redundancy through row group striping and maintain performance as the database 104 changes.

These conditions limit the possibilities of what can be done to allow row distribution. First, the columns for a given row of a given database 104 must be maintained on each hardware acceleration element 118. If the columns for a given row were kept on separate cards, this would preclude queries which required both columns.

With reference to FIG. 7, an example of a table 125 represented in database 104 is shown. Although a single table 125 is shown, it will be recognized by those having skill in the art that the method can be applied to multiple databases 104 and multiple tables 125.

In order to divide the database 104 correctly, groups of rows 126 are indexed into separate sets of bit vectors, lists and threads and placed in a single hardware acceleration element 118. In this example the table is divided into 7 row-groups that can be placed in the same or separate hardware acceleration elements 118. The space in the last row-group E may exceed beyond the end of the database data and may be used to store any new rows.

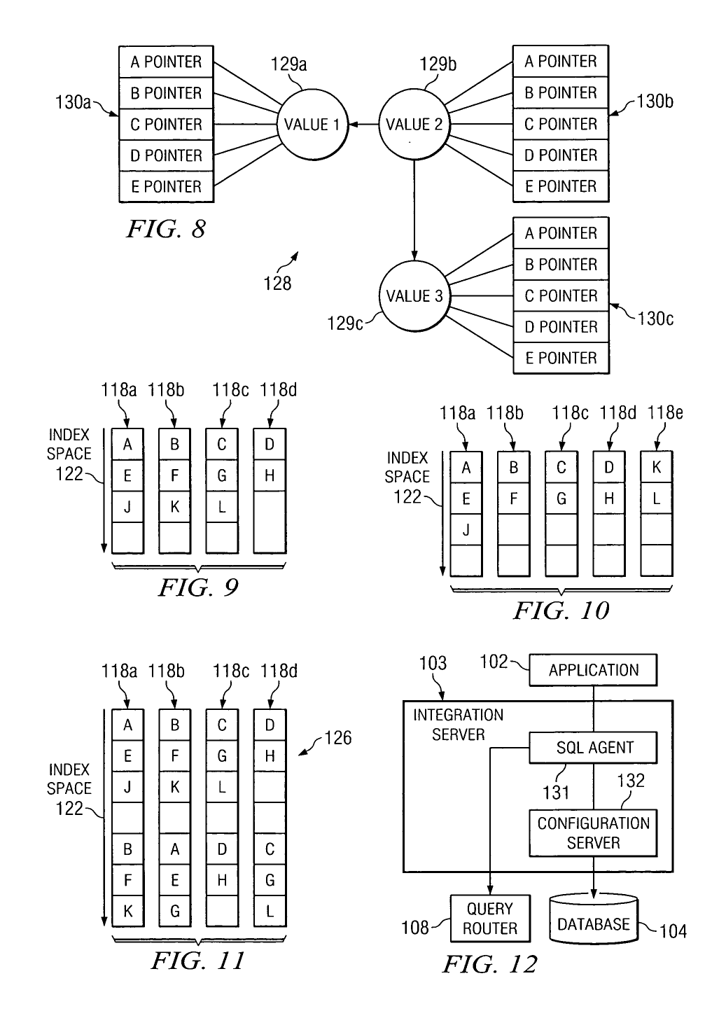

The balanced binary trees used in index engine indexing uses row-groups. In order to remain efficient, a single tree structure may be maintained although each node will contain pointers to the index structure for each row group. A balanced binary tree 128 for FIG. 7 is shown in FIG. 8. Note, for each node 129 in the tree 128, a row-group 126 could be any of the five valid index structures 130.

The binary balanced tree 128 is maintained in this manner to prevent the duplication of the individual nodes 129 in separate trees, thus improving the efficiency and performance of the system. Balanced binary trees 128 are maintained on the query router 106 which scales with the hardware that supports it, thereby improving binary balanced tree execution as standard computing platforms improve their performance.

A particular challenge is to determine the proper size of a row-group 126. If a row-group 126 is too small, overall efficient use of available memory will decrease, as each section receives a fixed amount of space, but doesn't necessarily utilize it all. Further, if a row-group 126 is too large, it will be harder to load-balance the system. In general, a row-group size will be optimized by the query router 106 on a system by system basis.

With reference to FIG. 9, the concept of row groups 126 allows the aggregate system to easily distribute indexes across several hardware acceleration elements 118 or index engines 110. The first step is calculating the row-group size and to generate all the row-groups 126 for a given database. The row-groups may be placed into the hardware acceleration elements 118 one at a time. After the associated memory 119 of each hardware acceleration element 118 stores a single row-group 126, the associated memory 119a of the first hardware acceleration element 118a receives a second row group 126 and so on. This is shown for row-groups A-L in FIG. 9.

As shown, the first three hardware acceleration elements 118a, 118b and 118c have a 50% higher workload than hardware acceleration element 118d. As the database 104 grows, the next row-group would be placed in the associated memory 119d of hardware acceleration element 118d.

By splitting row groups among several hardware acceleration elements 118, additional hardware acceleration elements 118 may be added to allow for database growth. With reference to FIG. 10, when a new hardware acceleration element 118e is added, a portion of the row groups 126 would be transferred to the new hardware acceleration element 118e. To do this, the query router 106 would recognize that there are 11 row-groups 126, with five hardware acceleration elements 118a, 118b, 118c, 118d and 118e. Thus, each hardware acceleration element 118 is assigned at least two row-groups 126. The query router 106 would then transfer the last row-groups from the second hardware acceleration element 118b and the third hardware acceleration element 118c, row groups K and L respectively, to the fifth hardware acceleration element 118e.

In the event of the failure of a hardware acceleration element 118, the indexes may be recovered from a backup disk array. Recovery in this manner may result in system downtime. Recovery downtime may be avoided by placing redundant row-groups 126 in multiple hardware acceleration elements 118. Although N+1 redundancy may not be provided with the index engine architecture, 1+1 redundancy is possible.

With reference to FIG. 11, a redundancy configuration is shown. The row groups 126 are simply stored in two redundant sets of hardware acceleration elements 118a and 118b forming the first redundant set and 118c and 118d forming the second redundant set. This configuration requires two times the index space.

In the figure shown, there are sufficient remaining space in each hardware acceleration elements 118 to store the redundant row-groups 126, otherwise more hardware acceleration elements 118 would be needed. Although this may require more hardware, the additional hardware acceleration elements 118 also allow for higher performance as tasks can now be completed in parallel at twice the speed. In this example, the first hardware acceleration element 118a is replicated in a second hardware acceleration element 118b and the third hardware acceleration element 118c is replicated in a fourth hardware acceleration element 118d. Either hardware acceleration element 118 of each pair can fail and the index engine 110 will continue to function.

With reference to FIG. 12, a block diagrams of the functions of the integration server 103 are shown. The application 102 communicates with an SQL agent 131. The SQL agent 131 parses SQL statements and translates results for communication with the application 102. The SQL agent 131 may communicate with a configuration server 132 which manages the integrated database indexing system 100 configuration.

When a query is submitted to the integrated database indexing system 100, the integration server 103 receives the query from the query source 102. The integration server communicates the query to the query router 106. The query router 106 parses the query and creates execution trees. The execution trees are communicated to the index engine 110. Results are retrieved from the index engine 110. A new query may be formulated and passed to the integration server 103. Result rows are retrieved from the underlying database 104, transformed by the integration server 103 and sent back to the query source 102.

Parsing the query is accomplished by first breaking the input query up into a set of tokens. Each token is then categorized and stored in a query structure. A query structure might look like:

struct query{op=0×01(SELECT), table=“s”, columns={“a”,“b”,“c”}}

The amount of time taken by the query router 106 to parse such a query depends largely on the number of tokens in the query string and the number of comparisons to be made one each token. After parsing, the query router 106 queries its metadata catalog to resolve native table and column names into their virtualized counterparts and the parsing structure is stored for further use.

The metadata catalog used by an index engine 110 is broken up into two pieces: a master metadata tree that records information about the databases 104 serviced by the query router 106 and a persistent, disk-based metadata repository. The master metadata tree provides quick access to the metadata for the query router 106 and reduces the number of disk I/Os necessary to retrieve the underlying metadata.

The master metadata is a balanced binary tree whose nodes represent databases. At each node of the tree is an information block that provides information about the database such as its type (Oracle, DB2, etc.) its location (possibly an IP address), and the tables managed by the query router 106 for that database 104; part of the table information is a list of columns 127 that belong to the given table. Information for a given table 125 may be stored sequentially in the persistent store. A single read of the disk may obtain all information about a given table 125. In order to query all databases 104, simultaneously, for the existence of a given table 125, all that is required is multiple threads of execution with each thread querying a single database 104.

As a first step in building the execution trees, the query router 106 must now look up the virtualized columns in its master index trees. At the nodes for each column in the master index tree is a “master directory” that specifies where the values for the column begin in the column index tree. Once the correct “master directory” is known a value search chan begin. Since the value searches take place on a perfectly balanced binary tree with minimal path length, access time for n nodes of the tree will be n(log n)+O(n).

After determining the virtualized column names, the query router 106 is ready to build the execution trees. At this point in the process, all that is required is to encapsulate the information obtained from parsing the query with the virtualized column names. Once created, the execution trees are then put into the appropriate sequence.

Once the execution trees have been built and sequenced, the execution trees may be communicated to the index engine 110. When the query router 106 communicates the execution trees to the index engine 110, it determines the maximum send buffer size that can be used to hold the execution trees. Once the size is determined, the query router 106 performs a send operation as many times as necessary with the given buffer size and creates off a thread to wait for the results. This thread then intercepts completion messages for all known index engines and collects the results.

When the thread created terminates, the query router places the results obtained from the index engine 110 into a result list. Upon receipt of the results, the query router 106 joins the results into a final result set.

The query router 106 uses the final result set to formulate a query to retrieve the rows of interest from the database or databases 104 hat contain the information asked for in the query. The query router 106 combines information obtained from the parsing step with the RowIDs retrieved from the index engine 110.

The query is then communicated back to the integration server 103. When the integration server 103 receives the re-formulated query, it submits it to the database or databases 104. When the integration server receives results from the DBMS 114 of the database 104, the integration server 103 then applies any requested output transformation until it runs out of results to transform. At that point, the results are returned to the query source 102.

The performance of the index engine 110 for a given query may depend on the number of hardware acceleration elements 118 in index engine 110; the number of indexed columns 127 present in the query; the number of values present (cardinality) for each indexed column 127; the number of row groups 126 in the target table 125; the latency of a given targeted database management system 114; the network latency and the network bandwidth.

To show how each of these components contributes to overall query performance, consider the following simple query:

SELECT a,b,c FROM S

For the purposes of this example, we will assume that all of a, b and c are present in the system and that each of these columns 127 is indexed. In the scenario where none or a significant number of the columns 127 in the query are not indexed by the index engine system, the query router 106 will simply defer the query to the target database management system 114.

The simplicity of the query focuses on the primitive operations that must take place to fulfill this query without having to account for the impact of one or more table joins on performance. In any event, a table join may be represented as multiple iterations of the same simple operations.

There may be four tokens in the given query: SELECT, “a,b,c:, FROM, s. Assuming that each instruction on the host processor takes 1 nanosecond to complete, that each memory fetch takes 5 nanoseconds, that a given token forces an average of 7 additional comparisons and that each memory fetch requires 2 instructions. The instruction time may be considerably less where a RISC host processor is used. Such a comparison forces eight store instructions, eight load instructions, eight memory fetches, eight comparison instructions and an average of 31 branching instructions. The formula that expresses total time to parse one token is thus:

Tₚ=cᵢ(nₛ+nₗ+n_{c}+n_{b})+((c_{f}(n_{f}))+((2(c)(n_{f})))

where Tₚ is the total amount of time to parse one token, c is the cost of one instruction on the host processor, nₛ is the number of store instructions, nₗ is the number of load instructions, n_{b} is the number of comparison instructions, n_{b} is the number of branching instructions, n_{f} is the number of memory fetches and c_{f} is the cost of one memory fetch.

Applying the formula gives a figure of 111 nanoseconds per token. For the tokens given above, the total time would be 444 nanoseconds. If the list of tokens had included 1000 elements, the total parsing time would have been 111 microseconds.

Recall that the metadata system persists on disk and requires one read on average to lookup a table and its columns. For the query given above, then, only one 7.5 ms disk access is necessary. The time to navigate the master metadata tree is not included in this figure as it is negligible.

To accurately model the performance of building the execution trees, we must recall the fact that in a perfectly balanced binary tree with minimal path length, the access time for a node once it has been loaded into memory in n(lon g)+O(n). In addition to the node access time, the number of instructions necessary to load a node from disk into memory must be taken into account.

Our calculation assumes a node overhead of 24 bytes plus an average of 8 bytes to store a value at the node and a 7.5 millisecond seek time to get to the node of interest on the disk. We also assume that the time to load 8 bytes into memory is 20 nanoseconds and that each load into memory is one instruction (not at all uncommon on mode processors). Thus, to load one node into memory, the formula is:

T_{load}=Tₛₑₑₖ+((((N_{bytes}/8)(c_{f}))+(c(n)))

where T_{load} is the total load time, Tₛₑₑₖ is the total seek time, N_{bytes} is the number of bytes to load, c_{f} is the cost of one memory fetch and c is the cost of one instruction on the host processor and n is the number of instructions necessary to load all of the bytes into memory. In order to load one node into memory, then, requires 7.5000084 milliseconds.

In the case of n=10, approximately 75 milliseconds is needed to load the nodes from disk. Once they are loaded into memory, all 10 nodes can be traversed in 10(1)+10 or 20 nanoseconds. Thus, it takes approximately 75 milliseconds to load and traverse 10 nodes. At each node that matches, a list of physical addresses is gathered up and added to the execution tree. This is a memory to memory copy that should take approximately 50 nanoseconds. For a query that involves 20 values and needs to gather 20 lists, the time would be approximately 1.02 milliseconds. Added to the 75 milliseconds obtained earlier, we get a total figure of 76 milliseconds.

Assuming that the query router 106 is sitting on its own network segment and has access to 20% of a 1 Gb/s Ethernet connection, it can theoretically send and receive 204 Mb per second. In practice, the query router 106 is also limited by the MTU (Maximum Transmission Unit) size of the underlying network 107. If the MTU is 1500 (typical for TCP/IP networks) then the Query router 106 can send a maximum of 1500 bytes in one send and the index engine 110 could only receive 1500 bytes at a time. The remaining number of bytes would be buffered and retrieved by the index engine 110 as it needed those bytes. If the query router 106 has to send execution trees totaling 5,000 bytes (0.004 Mb) it would require 4 sends totaling 2 milliseconds.

If the index engine 110 sends back RowIDs totaling 100,000 bytes, it may take the query router 106 20 milliseconds to receive them. Thus round-trip time between the query router 106 and the index engine 110 in this case is 22 milliseconds.

As the performance factors in play inside the index engine 110 are non-intuitive, it is impossible to generalize the time it takes to fulfill a query once the execution trees have been received. We can, however, generalize performance from a higher level. The index engine 110 may consist of several hardware acceleration elements 118 and may have a bandwidth of 6.4 GB/s. If we assume that only 70% of the index engine's memory 119 will be used to store RowIDs, we can determine that we could read every RowID in the system in 3.5 seconds. A worst case query would require exactly half of the RowIDs.

Therefore in this embodiment, no query will take longer than 1.75 seconds once it has been received by the index engine. In the typical case, a query will require only a small percentage of the RowIDs. If we assume the average query takes 1/100 of the total RowIDs (definitely a huge query) we would expect a index engine time of approximately 17.5 ms. There is also a slight setup time of 100 ns per execution tree. For the extreme case of matching a given fingerprint, approximately 2000 execution trees are required; in the domain of time, this type of query would incur a setup time of 0.2 ms. We can assume, therefore, a total of 17.7 ms for the index engine portion of the query.

Once the index engine 10 has finished its processing and the query router 106 regains control, it formulates a new query that the integration server 103 sends to the target database management system 114. Assuming that the target database management system 114 reads the RowIDs in fairly large blocks, disk access time can be estimated as 7.5 ms per block read. Thus, if three block of information need to be read, total access time would be 22.5 milliseconds. If the database management system server 104 is not processing a heavy workload the total time to get the result rows should not be much more than the estimate; a value of 25 milliseconds could probably be safely assumed. If the database management system server 104 is processing a heavy workload then the time to get the result rows would probably be around 50 to 100 milliseconds.

The query router 106 may perform substantial processing in order to fulfill a query and there are many latencies within the system.

| Component | Number | Unit | Latency | Unit |
|---|---|---|---|---|
| Parsing | 1000 | tokens | .111 | milliseconds |
| Metadata Lookup | 1 | disk access | 7.5 | milliseconds |
| Build Execution Trees | 10 | nodes | 76 | milliseconds |
| Send Execution Trees | 5000 | bytes | 2 | milliseconds |
| Query | 1 | query | 17.7 | milliseconds |
| Receive RowIDs | 100,000 | bytes | 20 | milliseconds |
| Reconstruct query | 1 | query | 100 | milliseconds |
| Get rows from DBMS | 3 | blocks | 22.5 | milliseconds |
| TOTAL | — | — | 246 | milliseconds |

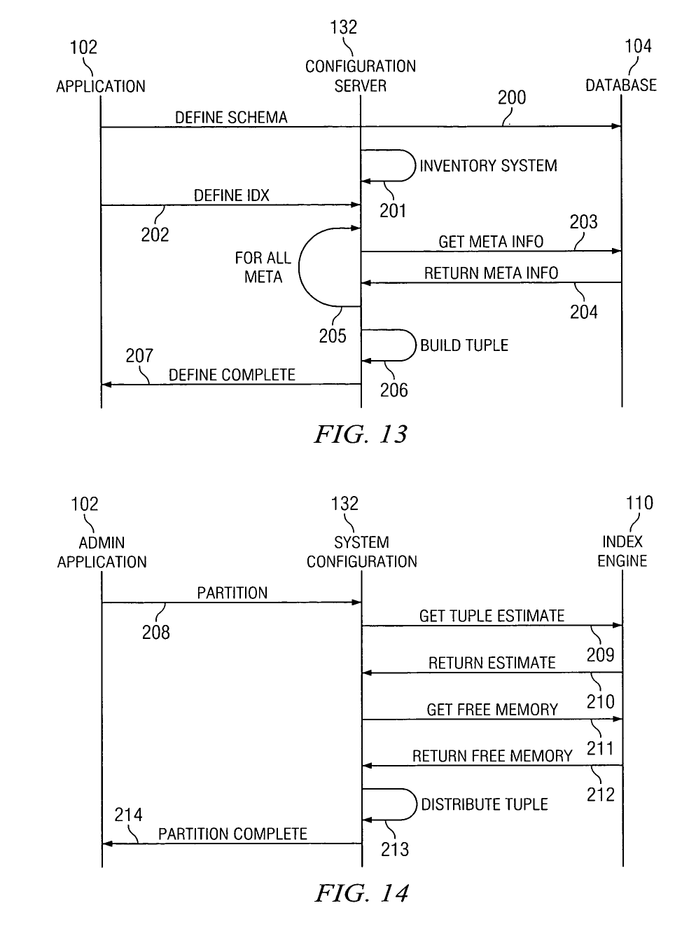

With reference to FIG. 13, a sequence diagram for defining indices to be accelerated is shown. The sequence involves an application 102, a configuration server 132, and a database 104. A define schema command 200, designated DefineSchema(FileName), is sent from the 102 application to the database 104. The define schema command 200 may include the name of a file containing the schema definition to be used by the database 104. The define schema command 200 is typically sent before the index engine 110 may define any indices.

The configuration server 132 performs an inventory system function 201, designated InventorySys( ), to determine the number and attributes of the index engines 110 installed on the integrated database indexing system 100, the available query routers 106, and the available SQL agents 131. The attributes may include the amount of memory, revision and other relevant details. The appropriate availability tables may be created.

The administration application 102 sends a define index command 202, designated Defineldx(Table, ColCount, Columns, Card, HiWtrLimit), to the system configuration facility 132. The define index function 202 defines the tables and columns to be indexed by the index engine 110, as well as the cardinality and high water alarm limit for each column. The define index function 202 typically uses arguments column count (ColCount), columns cardinality (Card) and high water limit (HiWtrLimit) for the table.

The system configuration facility 132 performs a for-all-meta loop function 205, designated ForAllMeta( ), which loops through all the tables and columns specified in the define index function 202 and performs the database's get-meta-information function 203, designated GetMetaInfo(Table, Column), for each of the tables and columns.

The get-meta-information functions 203 gets meta information associated with the specified table and column from the database 104. The meta information may include the column type, the column width, the current number of rows in the column and the uniqueness.

In response to the get-meta-info function 203, the database sends the requested meta data. The system configuration facility performs a return-meta-information function 204, designated RtnMetaInfo(Table, Column, Type, Width, CurDepth, Unique), which accepts meta information from the database. The meta information may include the table name, the column name, the column type, the column width, the current number of rows in the column and the uniqueness.

When the for-all-meta function 205 is completed, the system configuration facility 132 performs a build-tuple function 206, designated BuildTuple( ). The build-tuple function 206 builds a tuple descriptor for the tables and columns specified in the define index function 202. A tuple descriptor may include a tuple ID (TUPID), a table name (TNAME), a container ID (CID), and a record ID size (RSZ). For each column, column name (CNAME), key ID (KID), key type (KT), key size (KSZ) and key attributes (KAT) values may be defined. The new tuple will be added to the tuple table kept internally in the system configuration facility 132.

An administration application 102 define-complete function 207, designated DefineComplete(Status, TupID) receives the status from the system configuration facility. If the status is good, the tuple ID is also returned. The define operation is then complete.

With reference to FIG. 14, the sequence diagram for a partition function is shown. The administration application 102 sends a partition command 208, designated Partition(TupID, DistFI, RedunFI), to the system configuration facility. The system configuration facility 132 performs a partition function 208 to define how the user wishes to distribute the specified tuple across the available index engines 110. The distribution schemes may include (0), spreading across all the index engines 110, (1), kept to a single index engine 110 or (n), spread across n index engines 110. The redundancy state may be defined as simplex, where only one copy of the index is used and duplex where the index is mirrored. Typically, the system configuration facility 132 will define the partitions in response to a general distribution scheme defined by the application 102. In other embodiments, the application 102 may be able to manually set specific distribution parameters.

In response to the partition command 208, the system configuration facility 132 requests a tuple estimate from the index engine 110 using a get-tuple-estimate command 209, designated GetTupleEstimate(TupID). The get-tuple-estimate function 209 of the index engine 110 generates the amount of space in bytes that a row of the specified tuple would take up in an index engine 110.

A return tuple estimate function 210, designated RtnEstimate(NumBytes), at the system configuration facility 132 receives the amount of space in bytes that the specified tuple would take up in an index engine 110.

The system configuration facility 132 further requests the amount of free memory on the index engine 110 with a get-free-memory command 211, designated GetFreeMem( ). The index engine 110 performs a get-free-memory function 211, generating the total amount of memory on the index engine 110 and the total amount of free memory available on the index engine 110.

The index engine 110 provides the free memory data to the system configuration facility using a return-free-memory function 212, designated RtnFreeMem(TotalMem, FreeMem), providing both the amount of total memory available on the index engine 110 and the amount of total free memory available.

Using the memory information provided by the return-free-memory function 212, the system configuration facility 132 performs a distribute-tuple function 213, designated DistributeTuple( ). The distribute-tuple function 213 creates a tuple distribution map that specifies which index engines 110 will hold specified rows from the tuple.

When the distribution has been determined, a partition complete command 214, designated PartitionComplete(Status), including the status of the partition, is set to the administration application 102.

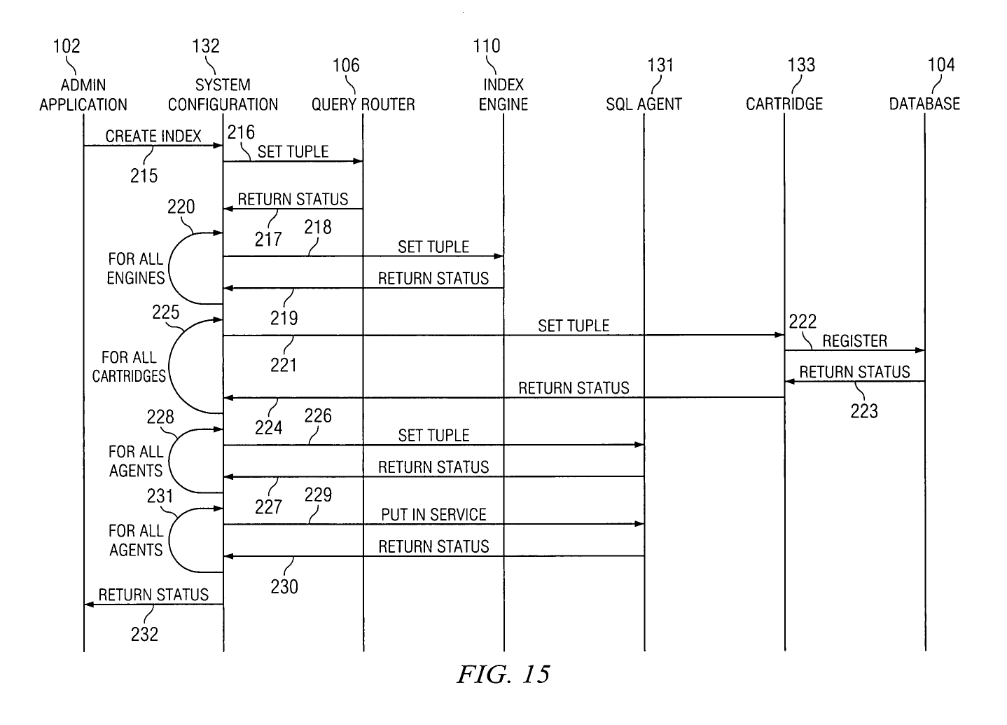

With reference to FIG. 15, a sequence diagram for a create index function is shown. An administration application 102 may send a create index command 215, designated Createldx(TupID), to the system configuration facility 132 to create an index. The create index function 215 of the system configuration facility 132 accepts a tuple ID from the administration application 102 and begins the sequence of steps necessary to create an index.

The system configuration facility 132 sends a set-tuple command 216, designated SetTuple(TupDes, IECnt, IEngID), with a tuple descriptor (TupDes), an index engine count (IECnt) and the IDs of the index engines (IEngID) to the query router 106. The query router 106 performs the set-tuple function 216 to take the supplied tuple descriptor and associates that tuple with the specified index engines. IEngID is an array of index engine IDs containing IECnt number of elements.

The query router 106 sends the requested data to the system configuration facility 132, which receives the data supplied in a return status command 217, designated RtnStatus(Status). If there is a problem, the administration application 102 is so informed.

The system configuration facility 132 subsequently performs a loop function 220, sending a set-tuple command 218, designated SetTuple(TupDes, MaxRows), to the index engines 110 for the tuples specified in the create index function 215.

The index engines 215, upon receiving the set-tuple command 218 with the tuple descriptor and a maximum row number value, from the system configuration facility 132. The index engine 110 takes the supplied tuple descriptor and creates the index structure for the specified number of rows.

The system configuration facility 132 receives a status signal from the index engines when it performs a return status function 219, designated RtnStatus(Status). If there is a problem, the administration application 102 is so notified.

The system configuration facility 132 performs a For-all-cartridges looping function 225, designated ForAllCart( ), that loops through all the database cartridges 133 in the system with a set-tuple command 221, designated SetTuple(TupDes). There is typically, at most, one database cartridge 133 for each database 104.

A designated database cartridge 133, upon receiving a set-tuple command 221 with the tuple descriptor, uses the supplied tuple descriptor to get the fields that need to be registered with the database 104. For each of the fields, a database register function 222, designated Register(Operation, Table, Column, Function) will typically be called to register operations, such as Insert, Delete and Update.

When the database 104 receives a Register command 222 including the operation, table, column and a function, the database 104 performs a Register function 222, registering that the specified function is to be called when the specified operation to be execution on a specified table or column. When the register function 222 has been performed, the database 104 sends a return status command 223, designated RtnStatus(Status), to the database cartridge 133. The database cartridge 133, in turn, sends a return status command 224, designated RtnStatus(Status) to the system configuration facility 132. If there is a problem indicated in the status, the admin application 102 is so notified.

The system configuration facility 132 performs a for-all-agents function 228, designated ForAllAgents( ), that loops through all the SQL Agents 131 in the system 100 and sends a set-tuple command 226, designated SetTuple(TupDes), to each of the SQL agents 131.

When the SQL agent 131 receive the set-tuple command 226 with the tuple descriptor, the SQL agent 131 uses the supplied tuple descriptor to determine which fields will be handled by the accelerators 110. When the set tuple function 226 has been performed, the SQL agent 131 sends a return status command 227, designated RtnStatus(Status) to the system configuration facility 132. If there is a problem indicated in the status, the admin application 102 is so notified.

The system configuration facility 132 performs a for-all-agents looping function 231, designated ForAllAgents( ), that loops through all the SQL Agents 131 in the system and sends a put-in-service command 229, designated PutInService( ), to each of the SQL agents 131.

When the SQL agents 131 receive a put-in-service command 229, the SQL agent 131 performs a put-in-service function and becomes operational. A return status signal 230, RtnStatus(Status), is sent from the SQL agent 131 to the system configuration facility 132. If there is a problem indicated in the status, the admin application 102 is so notified.

When the loops have been completed, the system configuration facility 132 sends a return status command 232, designated RtnStatus(Status), to the admin application 102. At this point, the create index function 215 is completed.

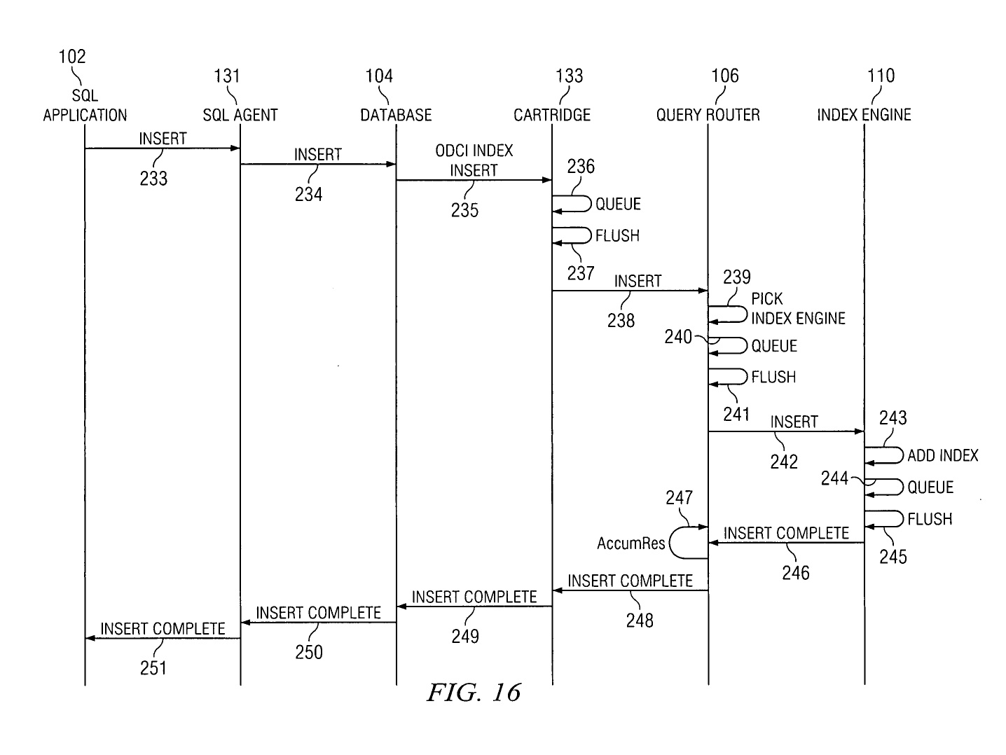

With reference to FIG. 16, a sequence diagram for an insert operation is shown. The insert operation typically involves interactions between an SQL application 102, an SQL agent 131, a database 104, a database cartridge 133, a query router 106 and an index engine 110.

The SQL Application 102 sends an insert request 233, designated Insert(SQL Text), to the database 104 to insert a record into a specified table. A typical SQL command may have the following syntax:

INSERT INTO table <<column< . . . >>>VALUES (value< . . . >);

The SQL Agent 131 may simply pass an SQL Insert command 234 through to the database 104. The database 104 typically recognizes the table's registered index and calls the database cartridge 133.

The database 104 sends an ODCI index insert request 235 to the database cartridge 133, designated ODCIIndexInsert([ColumnName, Values], RowID) with values for the column name (Column Name), the values (Values) and RowID. The database cartridge 133 provides an ODCI index insert function 235 bound to the table and columns in the application schema. This function adds the record ID and key value associations for the indices for the specified fields (columns). All columns and key values are provided by the database 104. The RowID and the key name and key value pairs are sent to the query router in a single insert message.

A database cartridge queue step 236, designated Queue(InsAtom), is performed internally by the database cartridge 133. The function consists of placing an “−insert atom” onto the output queue for the query routers 106. The insert atom may include an insert tag (I), an Atom ID (ATMID), a container ID (CID), a key ID (KID), a key value (KV), a record ID (RECID) and a Token stack (TKSTK) with return address tokens, five deep.

When the queue gets filled or upon a configured timeout, a flush function 237, designated Flush(InsAtom), transmits the contents of the queue to the query router 106.

The database cartridge 133 sends an insert command 238, designated Insert(InsAtom) to the query router 106. The query router 106 performs a pick index engine function 239, designated PickIE(InsAtom), to determine a candidate set of index engines 110 that are holding instances of the container defined in InsAtom. The query router 106 uses a resource distribution function to pick the final index engine 110. The distribution function is responsible for insuring that the index engines 110 receive equal load. The query router 106 adds a token to the token stack in the atom and forwards the message to the chosen index engine 110.

The query router 106 performs an internal queue function 240, designated Queue(InsAtom) that consists of putting an “insert atom” onto the output queue for the index engines 110. A flush function 241, designated Flush(InsAtom), transmits the contents of the queue to the index engines 110. The flush function 241 is typically performed when the queue gets filled or upon a configured timeout.

An insert command 242, designated Insert(InsAtom), is sent from the query router 106 to the appropriate index engine 110. In response to the insert command 242, the index engine 110 performs an add index step 243, designated AddIndex(InsAtom). The add index function 243 attempts to add the specified key or record ID association into the index's tree structure. The add index function 243 assigns a bit number to the record and inserts the record ID (RecID) into the RowID array element designated by the bit number.

When the result of the add index step 243 is determined, a queue function 244, designated Queue(ResAtom), occurs in which a response atom is put onto the queue for the appropriate query router return address, determined from the token stack in the insert atom. The response atom may contain a response tag (R), an Atom ID (ATMID), a result code (RESCD) and a token stack (TKSTK) with return address tokens, five deep.

The index engine 110 performs a flush function 245, designated FLUSH(ResAtom), to transmit the contents of the queue to the query router 106. The flush function 245 is performed when the queue is full or upon a configured timeout.

The query router 106 performs an accumulate response function loop 247, designated AccumRes( ) to accumulate the responses from the index engines 110 to which it routed the insert atom. Each index engine 110 creates an insert complete command 246 for transmission to the query router 106 in response. When all the responses have been accumulated by the query router 106, a response atom is created and sent to the database cartridge 133.

When the database cartridge 133 receives the insert complete command 248 from the query router 106, the database cartridge 133 converts the response code in the response atom into an appropriate status code 249 for the database 104.

The database 104 sends the insert complete command 250 to the SQL agent 131. The SQL agent 131 sends an insert complete command 251 to the SQL application 102. The insert operation is thereby completed.

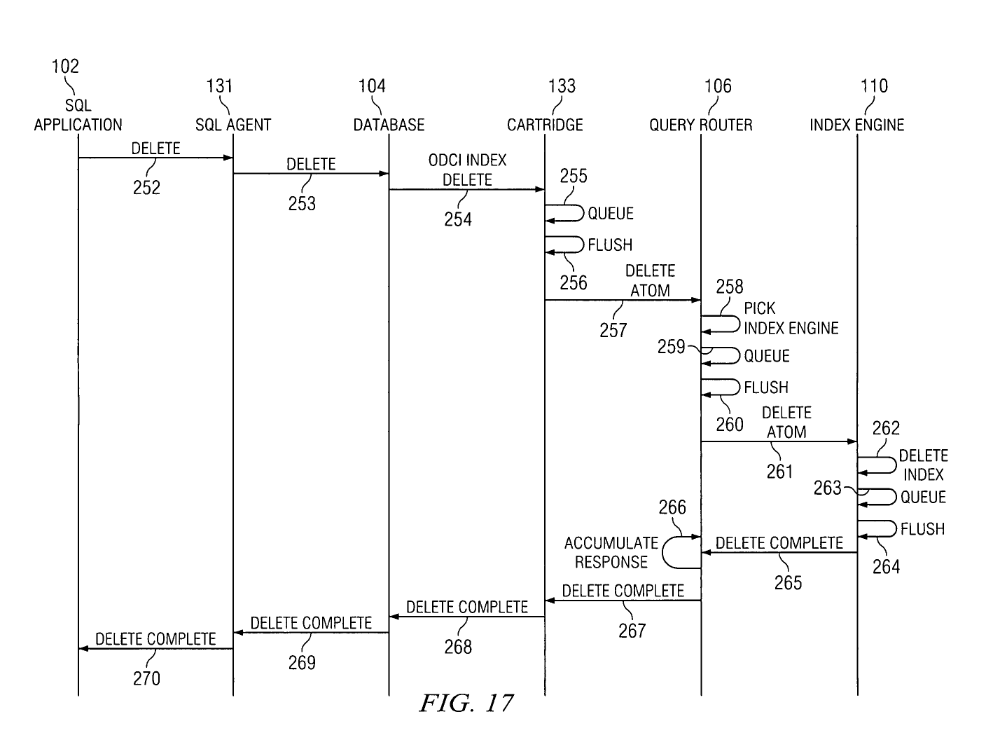

With reference to FIG. 17, a sequence diagram for the process of deleting a key from an index is shown. The delete key process typically involves communication between an SQL application 102, an SQL agent 131, a database 104, a database cartridge 133, a query router 106 and one or more index engines 110.

When the SQL application 102 sends a delete command 252, designated Delete(SQL Text), to delete a record from a specified table. A typical SQL command may have the following syntax:

DELETE FROM table <WHERE conditions>;

The SQL Agent 131 passes the SQL delete command 253 to the database 104.

When the database 104 receives the delete command 253, the database 104 recognizes the table having a registered index and calls the database cartridge 133 with an ODCI index delete command 254, designated ODCIIndexDelete([ColumnName, Values], RowID).

The database cartridge 133 receives the ODCI index delete command 254 and provides an ODCI index delete function bound to the table and columns in the application schema. This function requests that the record ID and key value associations be deleted from the indices for the specified fields or columns. All columns and key values are provided by the database 104. The RowID and the key name/key value pairs are sent to the query router 106 in a single delete message.

The database cartridge performs a queue step 255, designated Queue(DelAtom) internally by placing a “delete atom” onto the output queue for the query router 106. The delete atom may contain a delete tag (I), an atom ID (ATMID), a container ID (CID), a key ID (KID), a key value (KV), a record ID (RECID) and a token stack (TKSTK) including return address tokens, five deep.

The database cartridge 133 performs a flush function 256, designated Flush(DelAtom), that transmits the contents of the queue to the query router 106. The flush function 256 is performed when the queue becomes full or upon a configured timeout.

A delete atom command 257, designated Delete(DelAtom), is sent from the database cartridge 133 to the query router 106. The query router 106 performs a pick index engine function 258, designated PickIE(DelAtom), that determines the candidate set of index engines 110 that are holding instances of the container defined in a delete atom value, DelAtom. The query router 106 uses a hashing function to pick the appropriate index engine or engines 110. The query router 106 adds a token to the token stack in the atom and forwards the message to the specified index engine 110.

The query router 106 may then perform an internal queue command 259, designated Queue(DelAtom), with the value of DelAtom. The queue function 259 places a “delete atom” onto the output queue for the index engines 110.

The query router 106 may then perform a flush function 260, designated Flush(DelAtom), that transmits the contents of the queue to the index engines 110. The flush function 260 is performed when the queue is filled or upon a configured timeout.

The query router 106 sends a delete command 261, designated Delete(DelAtom) to the index engine 110. The index engine 110 receives the delete atom from the query router 106.

Once the index engine 110 receives a delete atom, the index engine 110 may perform a delete index function 262, designated DelIndex(DelAtom). The delete index function 262 attempts to delete the specified key/record ID association from the index's tree structure. The delete index function 262 determines the bit number for the record and removes the RecID from the RowID array element designated by the bit number.

The index engine 110 internally performs a queue function 263, designated Queue(ResAtom) in which a response atom is put onto the queue for the appropriate query router return address as determined from the token stack in the delete atom. The response atom may contain a response tag (R), an atom ID (ATMID), a result code (RESCD) and a token stack (TKSTK) return address tokens and five deep.

The index engine 110 may perform a flush function 264, designated Flush(ResAtom), that transmits the contents of the queue to the query router 106. The flush function 264 is performed when the queue is filled or upon a configured timeout.

The query router 106 performs a loop accumulate responses function 266, designated AccumRes( ) to accumulate all the delete complete responses 265 from the index engines 110 to which it routed the delete atom. When all the responses have been accumulated, a delete complete atom 267, designated DeleteComplete(ResAtom), is created and sent to the database cartridge 133.

The database cartridge 133 sends a delete complete status 268, designated DeleteComplete(ResAtom), to the database 104. The database 104 sends a delete complete status command 269, designated DeleteComplete(Status), to the SQL Agent 131. The SQL Agent 131 sends a delete complete status command 270 to the SQL Application 102. The delete operation is thereby completed.

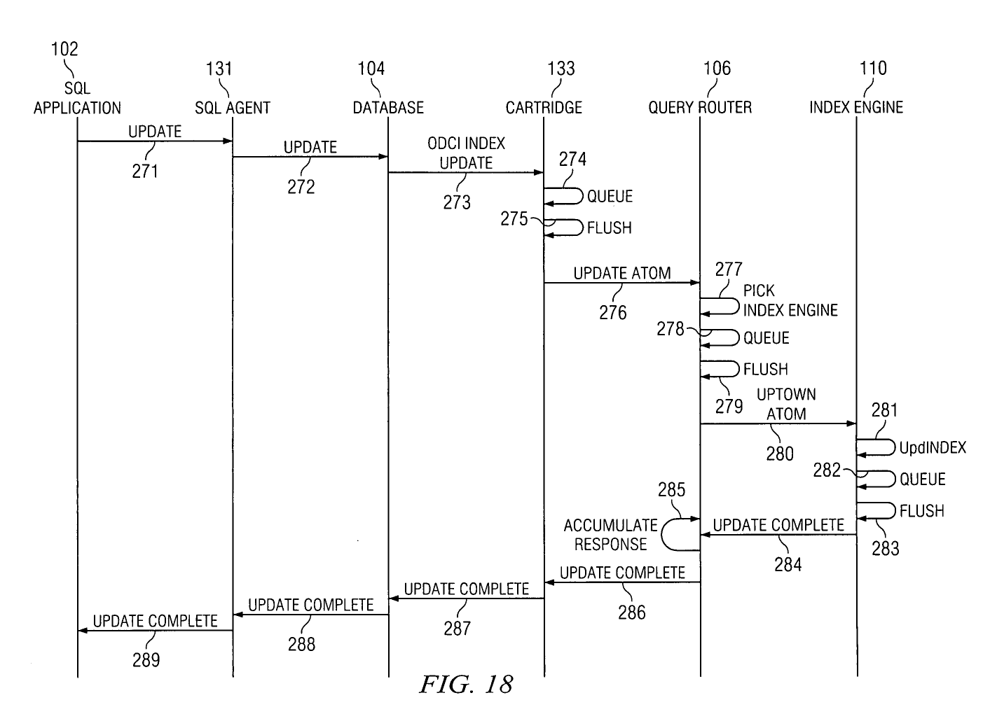

With reference to FIG. 18, a sequence diagram for an update index process is shown. The update index process typically involves interactions between an SQL application 102, an SQL agent 131, a database 104, a database cartridge 133, a query router 106 and an index engine 110.

The sequence initiates when the SQL application 102 sends an SQL update command 271, designated Update(SQL Text) to the SQL agent 131 to insert a record into a specified table. A typical SQL update command may have the following syntax:

UPDATE table SET column=value<, . . . ><WHERE conditions>;

The SQL Agent 131 passes the update command 272 to the database 104. The database 104 recognizes the table's registered index and sends an ODCI index update command 273, designated ODCIIndexUpdate ([ColumnName, OldValues, NewValues], RowID) to the database cartridge 133. The database cartridge 133 provides an ODCI index update function 273, designated ODCIIndexUpdate( ), bound to the table and columns in the application schema. The ODCI index update function 273 requests an update of the record/id key value associations from the old values (OldValues) to the new values (NewValues) in the indices for the specified fields (columns). All columns and key values are provided by the database 104. The RowID and the key name/key value pairs are sent to the query router 106 in a single update message.

The database cartridge 133 performs a queue function 274 internally. The queue function 274 is designated as Queue(UpdAtom). The queue function 274 places an “update atom” (UpdAtom) onto the output queue for the query router 106. The update atom may contain an update tag (I), an atom ID (ATMID), a container ID (CID), a key ID (KID), a key value-old (KVO), a key value-new (KVN), a record ID (RECID) and a token stack (TKSTK) return address tokens, five deep.

The database cartridge 133 performs a flush function 275, designated Flush (UpdAtom). The flush function 275 transmits the contents of the queue to the query router 106. The flush function 106 is performed when the queue is filled or the upon a configured timeout.

The database cartridge 133 sends an update request 276 to the query router 106, designated Update (UpdAtom). The query router 106 performs a pick index engine function 277, designated PickIE (UpdAtom). The query router PickIE function 277 determines a candidate set of index engines 110 that are holding instances of the container defined in the UpdAtom. The query router 106 uses a hashing function to pick the appropriate index engine or engines 110. The query router 106 adds a token to the tokenstack, in the atom, and forwards the message to the chosen index engine 110.

The query router 106 may perform a queue function 278 internally, designated Queue (UpdAtom). The queue function 278 typically consists of placing an update atom (UpdAtom) onto the output queue of the query router 106.

The query router 106 may perform a flush function 279, designated Flush (UpdAtom). The flush function 279 transmits the contents of the queue to the index engine 110. The flush function 279 is performed when the queue is filled or upon a configured timeout.

The query router 106 sends an update atom 280 to the index engine, designated Update (UpdAtom). When the index engine 110 receives the update atom (UpdAtom), the index engine 110 performs an update index function 281, designated UpdIndex(UpdAtom). The update index function 281 attempts to update the specified key/record ID association into the index's tree structure.

When the result of the update index function 281 is determined, an internal queue function 282, Queue(ResAtom), is performed. A response atom (ResAtom) is placed on the queue for the appropriate query router return address, determined from the token stack in the update atom. The response atom typically contains a response tag (R), an atom ID (ATMID), a result code (RESCD) and a token stack (TKSTK) including return address tokens, typically five deep.

The index engine 110 may then perform a flush function 283, Flush(ResAtom). The flush function 283 may transmit the contents of the index engine queue to a query router 106. The flush function 283 is performed when the queue is filled or upon a configured timeout.

Each index engine 110 that has received an update atom from the query router 106 sends an update complete command 284, designated UpdateComplete(ResAtom), to the query router 106. The query router 106 performs an accumulate response function 285; designated AccumRes( ), to accumulate the update responses from the index engines 110. The query router 106 may accumulate all of the responses from the index engines 110 to which an update atom has been routed. When all the responses have been accumulated, a response atom 286 is created and sent to the database cartridge 133.

The query router 106 sends an update complete atom to the database cartridge 133 which receives the atom using an update complete function 286, designated UpdateComplete(ResAtom). The database cartridge 133 converts the response code in the response atom into an appropriate status code for the database 104.

The database 104 receives the status code from the database cartridge 133 and performs an update complete function 287, designated UpdateComplete(Status). The database 104 sends the status to the SQL agent 131, which receives the code with an update complete function 288, designated UpdateComplete(Status). The update complete function 288 sends the status to the SQL application 102. The SQL application 102 performs an update complete function 289, designated UpdateComplete(Status). The update operation is completed.

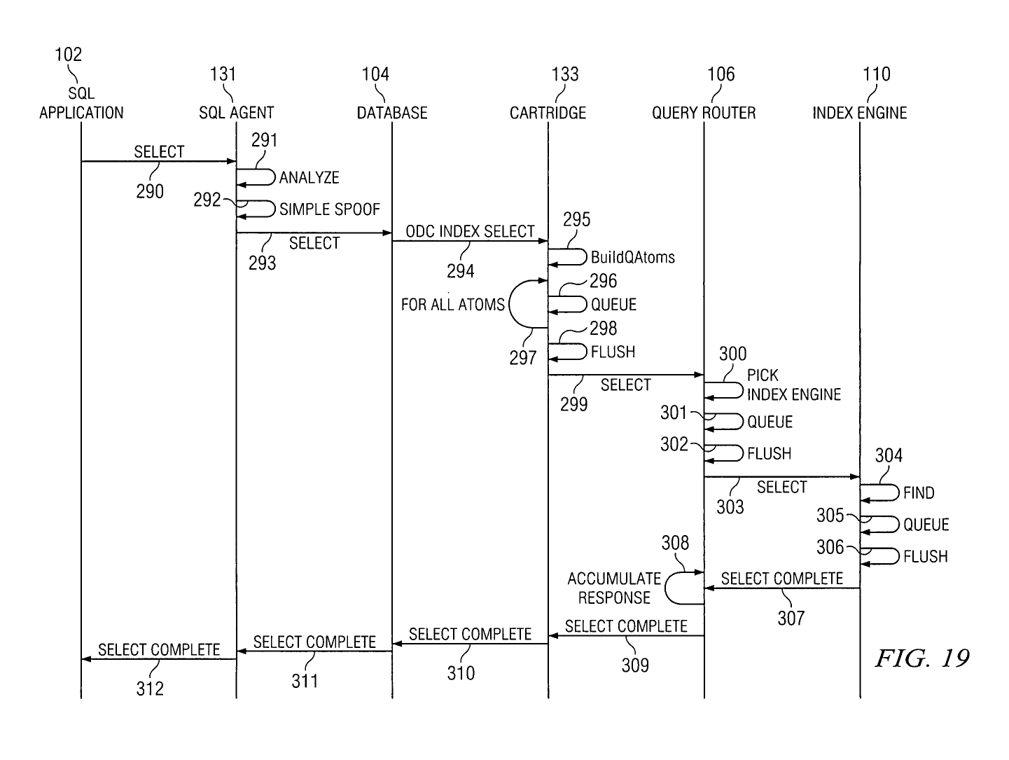

With reference to FIG. 19, a sequence diagram for a simple query on the integrated database indexing system 100. The simple query sequence typically involves interaction between an SQL application 102, an SQL agent 131, a database 104, a database cartridge 133, a query router 106 and an index engine 110.

To initiate a simple query, the SQL application 102 sends an SQL simple query command 290, designated Select (SQL Text) to an SQL agent 131. The simple query command 290 may be a request to find records meeting a specified predicate clause. A typical SQL command for a simple query may have the form:

SELECT column<, . . . >FROM table <WHERE conditions>.

The SQL agent 131 receives the query request command 290 from the SQL application with an select function, designated Select(SQL Text), where the SQL text defines the SQL command. The SQL agent 131 performs an analyze function 291, designated analyze (SQL Text). The analyze function 291 takes the SQL text parameter value, parses it and determines if the SQL text defines a simple query or a Boolean query. If all of the Boolean operations (AND, OR, etc.) are between results from accelerated fields, then the query is a Boolean query. Otherwise, the query is a simple query.

The SQL agent 131 performs a simple spoof function 292, designated SimpleSpoof( ). The simple spoof function takes the parsed info from the analyze function 291 and converts normal operations, such as=, >, etc., into accelerated operations, such as QEQ, QGT, etc., for any accelerated field. The simple spoof function 292 may then send the converted string to the database 104.

The database 104 receives the converted string with a select function 293, designated Select (SQL Text). The database 104 recognizes the registered index of the table and sends a request to the database cartridge 133.

The database cartridge 133 receives the request from the database 104 as an input to an ODC index select function 294, designated OCDIndexSelect(SQL Text). The ODC index select function 294 may be bound to the table and columns of the application schema. The ODC index select function 294 requests the integrated database indexing system 100 to determine the records that satisfy the specified predicate clause. One interface may return a list of record IDs to the database. In accordance with another embodiment, the interface may return an iterator.

The database cartridge 133 performs an internal build atoms function 295, designated BuildQAtoms( ). The build atoms function 295 takes the clause specified in the ODC index select function call 294 and breaks down the clause to create the query atom that needs to be sent to the index engine 110. A query atom may include a query tag (I), an atom ID (ATMID), a container ID (CID), a query string (QSTR) and a token stack (TKSTK) including return address tokens, typically five deep.

The database cartridge 133 performs a queue function 296, designated Queue(QAtom), for each of the atoms built by the build atom function 295. A for-all-atoms loop function 297, designated ForAllAtoms( ), cycles through the atoms so that they can be queued by the queue function.

When the atoms have been queued, the database cartridge 133 performs a flush function 298, designated Flush(QAtom). The flush function 298 transmits the contents of the queue to the query router 106. The flush function 298 is performed when the queue is filled or upon a configured timeout.

The database cartridge 133 sends a select request to the query router 106 which performs a select function 299, designated Select(QAtom) to accept the request. The query router 106 performs a pick index engine function 300, designated PickIE(QAtom). The query router pick index engine function 300 determines a candidate set of index engines 110 that hold instances of the container defined by the query atom. The query router 106 may use a hashing function to pick the appropriate index engine or engines 110. The query router 106 adds a token to the token stack in the query atom and forwards the message to the designated index engine 110.

The query router 106 performs a queue function 301, designated Queue(QAtom). The queue function 301 is performed internally. The queue function places a query atom onto the output queue for the index engine 110. The query router 106 performs a flush function 302, designated Flush(QAtom). The flush function 302 transmits the contents of the queue to the index engine 110. The flush function 302 is performed when the queue become filled or upon a configured timeout.

The index engine 110 receives the request from the query router by performing a select function 303, designated Select (QAtom). The index engine 110 performs a find function 304, designated Find(QAtom). The find function 304 locates all of the records that meet the criteria specified in the predicate clause of the query atom, QAtom.

When the result, ResAtom, of the find operation 303 is determined, the index engine performs a queue function 305 internally, designated Queue(ResAtom). The queue function 305 places a response atom onto the queue for the appropriate query router return address, as determined from the token stack in the query atom. The response atom may contain a response tag (R), an atom ID (ATMID), a result code (RESCD), a token stack (TKSTK) containing return address tokens, typically including return addresses stored five deep, a record count (CNT) and an array of record Ids containing CNT records (RECID).

The index engine 110 performs a flush function 306, designated Flush(ResAtom). The flush function 306 transmits the contents of the queue to the query router 106. The flush function 306 is performed when the queue is filled or upon a configured timeout.

The selected index engines 110 send the results, ResAtom, to the query router. The query router receives the results with a selection complete function 307, designated SelCompl(ResAtom). The query router 106 runs a loop function 308, designated AccumRes( ), to accumulate the results from each of the index engines 110 to which a query atom was routed. When all the results have been collected, the query router 106 creates a response atom for transmission to the database cartridge 133.

The database cartridge 133 receives the response atom with a select complete function 309, designated SelCompl(ResAtom). The select complete function 309 in the database cartridge 133 converts the response contained in the response atom, ResAtom, into the appropriate format for the database 104.

The database 104 receives the response from the database cartridge 133 with a select complete function 310, designated SelCompl(Res). The database 104 sends the response to the SQL agent, which receives the response with a select complete function 311, designated SelCompl(Res). The SQL agents sends the response to the SQL application which receives the response with a select complete function 312, designated SelCompl(Res). The simple query operation is thereby completed.

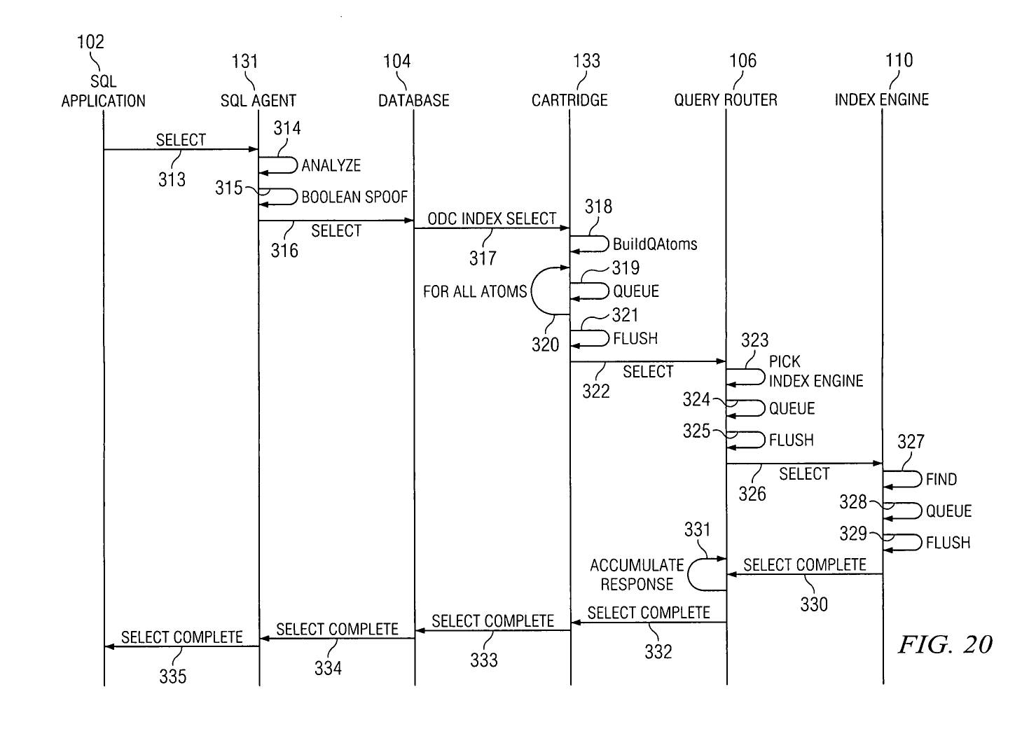

With reference to FIG. 20, a sequence diagram for a Boolean query on the integrated database indexing system 100. The Boolean query sequence typically involves interaction between an SQL application 102, an SQL agent 131, a database 104, a database cartridge 133, a query router 106 and an index engine 110.

To initiate a Boolean query, the SQL application 102 generates an SQL command and sends the SQL command to an SQL agent 131. The Boolean query may be a request to find records meeting a specified predicate clause. A typical SQL command for a Boolean query may have the form:

SELECT column<, . . . >FROM table <WHERE conditions>.

The SQL agent 131 receives the query request command from the SQL application 102 with an Select function 313, designated Select(SQL Text), where the SQL Text defines the SQL command. The SQL agent 131 performs an analyze function 314, Analyze (SQL Text). The analyze function 314 takes the SQL Text parameter value, parses it and determines if the SQL Text defines a simple query or a Boolean query. If all of the Boolean operations (AND, OR, etc.) are between results from accelerated fields, then the query is a Boolean query. Otherwise, the query is a simple query.

The SQL agent 131 performs a Boolean spoof function 315, designated BooleanSpoof( ). The Boolean spoof function 315 takes the parsed info from the analyze function 314 and converts normal operations, such as=, >, etc., into accelerated operations, such as QEQ, QGT, etc., for any accelerated field.

The Boolean spoof function 315 may convert the statement to a “foo” operation on the next table/column “Q/spoof” (a hidden table/column for this purpose) with the parameter to “foo” being the converted string. The Boolean spoof function 315 may then send the converted “foo” operation to the database 104. When this whole creation is sent to the database 104, the database 104 may call the function that has been registered in the database cartridge for “foo” on the Q/spoof field, and the steps necessary to perform the Boolean operations are executed in the index engines 110.

The database 104 receives the converted string with a select function 316, designated Select (SQL Text). The database 104 recognizes the registered index of the table and sends a request to the database cartridge 133.

The database cartridge 133 receives the request from the database 104 as an input to an ODC index select function 317, designated ODCIndexSelect(SQL Text). The ODC index select function 317 may be bound to the table and columns of the application schema. The ODC index select function 317 requests the integrated database indexing system 100 to determine the records that satisfy the specified predicate clause. One interface may return a list of record IDs to the database 104. In accordance with another embodiment, the interface may return an iterator.

The database cartridge 133 performs an internal build atoms function 318, designated BuildQAtoms( ). The build atoms function 318 takes the clause specified in the ODC index select function call 317 and breaking the clause to create the query atom that needs to be sent to the index engine 110. A query atom may include a query tag (I), an atom ID (ATMID), a container ID (CID), a query string (QSTR) and a token stack (TKSTK) including return address tokens, typically five deep.

The database cartridge 133 performs a queue function 319, designated Queue(QAtom), for each of the atoms built by the build atom function 318. A for-all-atoms loop function 320, designated ForAllAtoms( ) cycles through the atoms so that they can be queued by the queue function 319.

When the atoms have been queued, the database cartridge 133 performs a flush function 321, designated Flush(QAtom). The flush function 321 transmits the contents of the queue to the query router 106. The flush function 321 is performed when the queue is filled or upon a configured timeout.

The database cartridge 133 sends a select request to the query router 106 which performs a select function 322, designated Select(QAtom) to accept the request. The query router 106 performs a pick index engine function 323, designated PickIE(QAtom). The query router pick index engine function 323 determines a candidate set of index engines 110 that hold instances of the container defined by the query atom. The query router 106 may use a hashing function to pick the appropriate index engine or engines 110. The query router 106 adds a token to the token stack in the query atom and forwards the message to the designated index engine 110.

The index engine 110 receives the request from the query router 106 by performing a select function 326, designated Select (QAtom). The index engine 110 performs a find function 328, designated Find(QAtom). The find function 328 finds all of the records that meet the criteria specified in the predicate clause.

When the result, ResAtom, of the find operation 328 is determined, the index engine 110 performs a queue function 328 internally, designated Queue(ResAtom). The queue function 328 places a response atom onto the queue for the appropriate query router return address, as determined from the token stack in the query atom. The response atom may contain a response tag (R), an atom ID (ATMID), a result code (RESCD), a token stack (TKSTK) with return address tokens, with five deep, a record count (CNT) and an array of record Ids containing CNT records (RECID).

The index engine 110 performs a flush function 329, designated Flush(ResAtom). The flush function 329 transmits the contents of the queue to the query router 106. The flush function 329 is performed when the queue is filled or upon a configured timeout.

The index engines 110 sends the results, ResAtom, to the query router 106. The query router 106 receives the results with a selection complete function 330, designated SelCompl(ResAtom). The query router 106 runs a loop function 331, designated AccumRes( ), to accumulate the results from each of the index engines 110 to which a query atom was routed. When all the results have been collected, the query router 106 creates a response atom for transmission to the database cartridge 133.

The database cartridge 133 receives the response atom with a select complete function 332, designated SelCompl(ResAtom). The database cartridge 133 converts the response in the response atom, ResAtom, into the appropriate format for the database 104.

The database 104 receives the response from the database cartridge 133 with a select complete function 333, designated SelCompl(Res). The database 104 sends the response to the SQL agent 131, which receives the response with a select complete function 334, designated SelCompl(Res). The SQL agent 131 sends the response to the SQL application 102 which receives the response with a select complete function 335, designated SelCompl(Res). The Boolean query operation is thereby completed.

Although the illustrative embodiment has been described in detail, it should be understood that various changes, substitutions and alterations can be made therein without departing from the spirit and scope of the invention as defined by the appended claims.

What is claimed is:

1. An integrated database indexing system comprising:
an index engine communicably connected to a database having an extensible index and storing an index associated with said database; and
an application communicably connected to said database;
wherein said application sends a command to said database and a change is made to said index by said index engine in response to said command.

2. The integrated database indexing system of claim 1, wherein said application is an SQL application.

3. The integrated database indexing system of claim 2, further comprising an SQL agent connected to said application and said database, wherein said SQL application communicates a query to said SQL agent.

4. The integrated database indexing system of claim 1, wherein said database is an Oracle database.

5. The integrated database indexing system of claim 1, wherein said index engine comprises index engine hardware.

6. The integrated database indexing system of claim 1, further comprising a query router communicably connected to said database and said index engine.

7. The integrated database indexing system of claim 6, further comprising a plurality of index engines, wherein said query router selects a selected index engine and communicates said changes to said selected index engine.

8. The integrated database indexing system of claim 7, wherein said query router selects multiple index engines and communicates said command to said multiple index engines.

9. The integrated database indexing system of claim 1, wherein application sends a query command to said database.

10. The integrated database indexing system of claim 1, wherein said change is a delete command.

11. The integrated database indexing system of claim 5, wherein said index engine hardware comprises a hardware accelerator.

12. The integrated database indexing system of claim 1, further comprising an index agent connected to said database and said query router, wherein said database communicates a change to said index agent and said index agent communicates a command to said query router.

13. The integrated database indexing system of claim 1, wherein said change is a create index command.

14. An integrated database indexing method comprising the steps of:
receiving an indexing command by a database supporting extensible indexing;
communicating said indexing command to an index engine by said database; and
revising an index by the index engine in accordance with the indexing command.

15. The integrated database indexing method of claim 14, wherein said indexing command is received from an application.

16. The integrated database indexing method of claim 15, wherein said application is an SQL application.

17. The integrated database indexing method of claim 14 wherein said index is stored in said index engine.

18. The integrated database indexing method of claim 14 wherein said index engine comprises a hardware accelerator.

19. The integrated database indexing method of claim 14 wherein said step of communicating comprises communicating said indexing command to a query router by the database and communicating said indexing command to said index engine by said query router.

20. The integrated database indexing method of claim 19 wherein said query router communicates said indexing command to a selected one of a plurality of index engines.

21. The integrated database indexing method of claim 19 wherein said query router communicates said indexing command to each of a plurality of index engines.

22. The integrated database indexing method of claim 14 wherein said indexing command is a delete command.

23. The integrated database indexing method of claim 22 wherein said step of revising an index comprises deleting an index entry.

24. The integrated database indexing method of claim 14 wherein said indexing command is an add command.

25. The integrated database indexing method of claim 24 wherein said step of revising an index comprises adding an index entry.

26. The integrated database indexing method of claim 14 further comprising the steps of receiving a search command by a database supporting extensible indexing, communicating the search command to an index engine by a database and searching an index by the index engine in accordance with the search command.

27. The integrated database indexing method of claim 26 wherein the step of communicating the search command comprises communicating the search command to a query router by the database and communicating the search command to an index engine by a query router.

28. The integrated database indexing method of claim 27 wherein said query router communicates the search command to a selected one of a plurality of index engines.

29. The integrated database indexing method of claim 27 wherein said query router communicates the search command to each of a plurality of index engines.

30. An integrated database indexing method comprising the steps of:
receiving an indexing command by an index engine; and
revising an index by the index engine in accordance with the indexing command.

31. An integrated database indexing method comprising the steps of:
receiving a search command by an index engine;
searching an index by the index engine in accordance with the search command;
communicating said search results to a database corresponding to said index; and
retrieving search results from said database.

32. The integrated database indexing method of claim 31 further comprising the step of receiving a search command by a query router and sending a search command from the query router to an index engine.

33. The integrated database indexing method of claim 32 wherein said step of sending a search command comprises sending a search command from the query router to a selected one of a plurality of index engines.

34. The integrated database indexing method of claim 32 wherein said step of sending a search command comprises sending a search command from the query router to each of a plurality of index engines.

35. The integrated database indexing method of claim 31 wherein said database supports an extensible index.

36. The integrated database indexing method of claim 35 wherein said database is an Oracle database.

37. An index engine comprising:
an index agent for receiving indexing commands;
a memory for storing an index wherein said memory is connected to said index agent;
wherein said index agent revises said index stored in said memory in accordance with said received index commands.

38. The index engine of claim 37, wherein said index agent comprises a hardware accelerator.

39. The index engine of claim 37 comprising a plurality of index agents and a plurality of memory spaces wherein each of the plurality of index agents is associated with a memory space.

40. The index engine of claim 39 wherein a portion of said index is uniquely stored in a memory space.

41. The index engine of claim 39 wherein a portion of said index is redundantly stored in more than one memory space.

42. The index engine of claim 37 wherein the index agent receives indexing commands from a query router.

43. The index engine of claim 37 wherein the index agent receives indexing commands from an SQL application.

44. The index engine of claim 37 wherein the index agent receives indexing commands from a database.

45. The index engine of claim 44 wherein the database supports an extensible index.

46. A method of integrated database indexing comprising:
providing an index engine communicably connected to a database having an extensible index and storing an index associated with said database; and
receiving commands from an application communicably connected to said database;
wherein said application sends a command to said database and a change is made to said index by said index engine in response to said command.

47. The method of integrated database indexing of claim 46, wherein said application is an SQL application.

48. The method of integrated database indexing system of claim 47, wherein an SQL agent is connected to said application and said database, further comprising the step of communicating a query from said SQL application to said SQL agent.

49. The method of integrated database indexing of claim 46, wherein said database is an Oracle database.

50. The method of integrated database indexing of claim 46, wherein said index engine comprises index engine hardware.

51. The method of integrated database indexing of claim 46, wherein a query router is communicably connected to said database and said index engine.

52. The method of integrated database indexing of claim 51, wherein a plurality of index engines are provided, further comprising the step of selecting a selected index engine from said plurality of index engines by the query router and communicating said changes to said selected index engine.

53. The method of integrated database indexing of claim 52, further comprising the step of selecting multiple index engines and communicating said command to said multiple index engines.

54. The method of integrated database indexing of claim 46, further comprising the step of sending a query command to said database.

55. The method of integrated database indexing of claim 46, wherein said change is a delete command.

56. The method of integrated database indexing of claim 50, wherein said index engine hardware comprises a hardware accelerator.

57. The method of integrated database indexing of claim 46, wherein an index agent is connected to said database and said query router, further comprising the step of communicating a change to said index agent by a database and said index agent communicating a command to said query router.

58. The method of integrated database indexing of claim 46, wherein said change is a create index command.

59. An integrated database indexing system comprising:
a database supporting extensible indexing receiving an indexing command;
an index engine communicably connected to said database, wherein an indexing command is communicated to the index engine by said database; wherein said index engine revises an index in accordance with the indexing command.

60. The integrated database indexing system of claim 59, wherein said indexing command is received from an application.

61. The integrated database indexing system of claim 50, wherein said application is an SQL application.

62. The integrated database indexing system of claim 59 wherein said index is stored in said index engine.

63. The integrated database indexing system of claim 59 wherein said index engine comprises a hardware accelerator.

64. The integrated database indexing system of claim 59 wherein said indexing command is communicated to a query router by the database and said indexing command is communicated to said index engine by said query router.

65. The integrated database indexing system of claim 64 wherein said query router communicates said indexing command to a selected one of a plurality of index engines.

66. The integrated database indexing system of claim 64 wherein said query router communicates said indexing command to each of a plurality of index engines.

67. The integrated database indexing system of claim 59 wherein said indexing command is a delete command.

68. The integrated database indexing system of claim 67 wherein said index is revised by deleting an index entry.

69. The integrated database indexing system of claim 59 wherein said indexing command is an add command.

70. The integrated database indexing system of claim 69 wherein said index is revised by adding an index entry.

71. The integrated database indexing system of claim 59 wherein a search command is received by a database supporting extensible indexing and the search command is communicated to an index engine by a database and an index is searched by the index engine in accordance with the search command.

72. The integrated database indexing system of claim 71 wherein the search command is communicated to a query router by the database and the search command is communicated to an index engine by a query router.

73. The integrated database indexing system of claim 72 wherein said query router communicates the search command to a selected one of a plurality of index engines.

74. The integrated database indexing system of claim 72 wherein said query router communicates the search command to each of a plurality of index engines.

75. An integrated database indexing system comprising:
an index engine receiving an indexing command; and
an index communicably connected to said index engine, wherein said index is revised by the index engine in accordance with the indexing command.

76. An integrated database indexing system:
an index engine receiving a search command;
an index communicably connected to said index engine, wherein said index is searched by the index engine in accordance with the search command; and
a database associated with said index and communicably connected to said index engine, wherein said index engine communicates search results to said database and said database retrieves said search results.

77. The integrated database indexing system of claim 76, further comprising a query router connected to said index engine wherein a search command is received by a query router and said query router sends said search command to said index engine.

78. The integrated database indexing system of claim 77 wherein said query router sends a search command to a selected one of a plurality of index engines.

79. The integrated database indexing system of claim 77 wherein said query router sends a search command to each of a plurality of index engines.

80. The integrated database indexing system of claim 76 wherein said database supports an extensible index.

81. The integrated database indexing system of claim 80 wherein said database is an Oracle database.

82. An indexing method comprising:
receiving indexing commands by an index engine;
storing an index in a memory wherein said memory is connected to said index agent; and
revising said index stored in said memory in accordance with said received index commands.

83. The indexing method of claim 82, wherein said index agent comprises a hardware accelerator.

84. The indexing method of claim 82 wherein said index engine includes a plurality of index agents and a plurality of memory spaces wherein each of the plurality of index agents is associated with a memory space.

85. The indexing method of claim 84 wherein a portion of said index is uniquely stored in a memory space.

86. The indexing method of claim 84 wherein a portion of said index is redundantly stored in more than one memory space.

87. The indexing method of claim 82 further comprising the step of receiving indexing commands at the index engine from a query router.

88. The indexing method of claim 82 further comprising the step of receiving indexing commands from an SQL application.

89. The indexing method of claim 82 wherein the index agent receives indexing commands from a database.

90. The indexing method of claim 89 wherein the database supports an extensible index.
